(19) United States
(12) Patent Application Publication
(10) Pub. No.: US 2025/0247139 A1
(43) Pub. Date: Jul. 31, 2025

(54) METHOD AND APPARATUS FOR TRANSMITTING AND RECEIVING OF INFORMATION

(71) Applicant: Samsung Electronics Co., Ltd., Gyeonggi-do (KR)

(72) Inventors: Zhe CHEN, Beijing (CN); Jingxing FU, Beijing (CN); Feifei SUN, Beijing (CN); Bin YU, Beijing (CN)

(21) Appl. No.: 18/853,242

(22) PCT Filed: Jul. 13, 2023
(86) PCT No.: PCT/KR2023/010021

§ 371 Date: Oct. 1, 2024

(30) Foreign Application Priority Data
Jul. 15, 2022 (CN) 202210837139.6
Sep. 14, 2022 (CN) 202211116163.7
Oct. 26, 2022 (CN) 202211321657.9

(51) Int. Cl. H04B 7/06; H04L 27/26; H04W 72/0446; H04W 72/232

(52) U.S. Cl. CPC H04B 7/06952; H04L 27/26025; H04W 72/0446; H04W 72/232

(57) ABSTRACT

The disclosure relates to a 5G or 6G communication system for supporting a higher data transmission rate. An aspect of the disclosure provides a method performed by a repeater in a communication system and the repeater performing the method, wherein the method comprises: receiving first beam information from a base station; and applying the first beam information for downlink forwarding and/or uplink reception. Another aspect of the disclosure provides a method performed by a repeater in a communication system and the repeater performing the method, wherein the method comprises: receiving a plurality of beam information from a base station; determining a mapping relationship and/or a grouping relationship between the plurality of beam information.

### TECHNICAL FIELD

The present application relates to the technical field of wireless communication. More particularly, the disclosure relates to a method and device for receiving and transmitting information.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

This disclosure relates to wireless communication networks, and more particularly to a terminal and a communication method thereof in a wireless communication system.

In accordance with an aspect of the disclosure, applying the first beam information for downlink forwarding and/or uplink reception includes: determining a corresponding spatial filter according to the first beam information; and performing downlink forwarding and/or uplink reception based on the determined spatial filter.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an overall structure of an example wireless communication network according to various embodiments of the disclosure;

FIG. 2A illustrates a transmission path 200 in a wireless communication network according to various embodiments of the disclosure;

FIG. 2B illustrates a reception path 250 in a wireless communication network according to various embodiments of the disclosure;

FIG. 3A illustrates the structure of a user equipment (UE) in a wireless communication network according to various embodiments of the disclosure;

FIG. 3B illustrates the structure of a base station in a wireless communication network according to various embodiments of the disclosure;

FIG. 4 illustrates an example network including an NCR according to various embodiments of the disclosure;

FIG. 5 illustrates an example structure of an NCR according to various embodiments of the disclosure;

FIG. 6 illustrates a method 600 performed by an NCR according to various embodiments of the disclosure;

FIG. 7 illustrates another method 700 performed by an NCR according to various embodiments of the disclosure;

FIG. 8 illustrates a method 800 performed by a base station according to various embodiments of the disclosure;

FIG. 9 illustrates another method 900 performed by a base station according to various embodiments of the disclosure;

FIG. 10 illustrates a structure 1000 of a UE according to various embodiments of the disclosure;

FIG. 11 illustrates a structure 1100 of a repeater according to various embodiments of the disclosure; and

FIG. 12 illustrates a structure 1200 of a base station, according to the embodiments as disclosed.

Throughout the drawings, it should be noted that like reference numbers are used to depict the same or similar elements, features, and structures.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

An aspect of the disclosure provides a method performed by a repeater in a communication system, wherein the method includes: receiving first beam information from a base station; and applying the first beam information for downlink forwarding and/or uplink reception.

In one aspect, applying the first beam information for downlink forwarding and/or uplink reception includes: determining a corresponding spatial filter according to the first beam information; and performing downlink forwarding and/or uplink reception based on the determined spatial filter.

In another aspect, the first beam information includes a beam identification ID and reference signal related information, and determining the corresponding spatial filter according to the first beam information includes: if the beam ID is associated with the reference signal related information, determining the corresponding spatial filter according to the reference signal related information; or if the beam ID is not associated with the reference signal related information, determining the corresponding spatial filter according to the beam ID.

In another aspect, applying the first beam information for downlink forwarding and/or uplink reception includes: applying the first beam information for downlink forwarding and uplink reception after a first time of transmitting a signal or channel carrying feedback for the first beam information or a second time of receiving a signal or channel carrying the first beam information, if the first beam information is different from the second beam information previously received by the repeater.

In another aspect, applying the first beam information for downlink forwarding and/or uplink reception includes: applying the first beam information for downlink forwarding and/or uplink reception on time domain resources and/or frequency domain resources indicated by the base station.

In another aspect, applying the first beam information for downlink forwarding and/or uplink reception includes: applying the first beam information for downlink forwarding and/or uplink reception according to power indicated by power information indicated by the base station.

In another aspect, the first beam information includes at least one of the followings: a beam identification ID; reference signal related information; a transmission configuration indication TCI status ID; a panel ID; cell-related information and/or bandwidth part BWP information.

Another aspect of the disclosure provides a method performed by a repeater in a communication system, wherein the method includes: obtaining a time domain information set from a base station; and determining a size of a field of the downlink control information DCI format based on the time domain information set.

In one example, the field of the DCI format includes at least one of the followings: a beam information field; a switch field; an uplink and downlink field; a time domain resource field.

Another aspect of the disclosure provides a method performed by a repeater in a communication system, wherein the method includes: receiving a plurality of beam information from a base station; determining a mapping relationship and/or a grouping relationship between the plurality of beam information.

In one aspect, determining the mapping relationship and/or grouping relationship between the plurality of beam information includes: determining the mapping relationship and/or grouping relationship between the plurality of beam information according to a predefined rule; or receiving information including the mapping relationship and/or grouping relationship between the plurality of beam information from the base station; or determining the mapping relationship and/or grouping relationship between the plurality of beam information, and reporting the determined mapping relationship and/or grouping relationship between the plurality of beam information to the base station.

In another aspect, the mapping relationship between the plurality of beam information is a 1 to N mapping relationship.

In another aspect, the method further includes: determining at least one beam information group according to the grouping relationship, wherein beam information of different beam information groups can be simultaneously applied to downlink forwarding and/or uplink reception by the repeater.

In another aspect, after reporting the determined mapping relationship and/or grouping relationship between the plurality of beam information to the base station, the method includes: receiving, from the base station, feedback for the mapping relationship and/or grouping relationship between the plurality of beam information; and if the received feedback is acknowledgement ACK feedback, applying the mapping relationship and/or grouping relationship between the plurality of beam information.

In another aspect, the feedback is indicated by transmission configuration indication TCI state activation signaling or TCI state update signaling; and/or the feedback is indicated by a Physical Downlink Control Channel PDCCH carrying downlink control information DCI.

Another aspect of the disclosure provides a method performed by a base station in a communication system, and the method includes: determining first beam information for instructing a repeater to perform downlink forwarding and/or uplink reception; transmitting the first beam information to the repeater.

Another aspect of the disclosure provides a method performed by a base station in a communication system, wherein the method includes: transmitting or receiving a plurality of beam information to or from a repeater; the plurality of beam information is used to determine the mapping relationship and/or grouping relationship between the plurality of beam information.

In one aspect, determining the mapping relationship and/or grouping relationship between the plurality of beam information includes: determining the mapping relationship and/or grouping relationship between the plurality of beam information according to a predefined rule; or determining the mapping relationship and/or grouping relationship between the plurality of beam information, and indicating the determined mapping relationship and/or grouping relationship between the plurality of beam information to the repeater; or receiving the mapping relationship and/or grouping relationship between the plurality of beam information reported by the repeater.

In another aspect, after receiving the mapping relationship and/or grouping relationship between the plurality of beam information reported by the repeater, the method includes: transmitting feedback for the mapping relationship and/or grouping relationship between the plurality of beam information to the repeater; and if the sent feedback is acknowledgement ACK feedback, applying the mapping relationship and/or grouping relationship between the plurality of beam information.

Another aspect of the disclosure provides a repeater including a first unit and a second unit, and the first unit is configured to receive first beam information from a base station; and the second unit is configured to apply the first beam information for downlink forwarding and/or uplink reception.

Another aspect of the disclosure provides a repeater including a first unit and a second unit, and the first unit is configured to receive a plurality of beam information from a base station; and determine a mapping relationship and/or a grouping relationship between the plurality of beam information.

Another aspect of the disclosure provides a base station including a transceiver and a processor coupled to the transceiver, wherein the processor is configured to determine first beam information for instructing a repeater to perform downlink forwarding and/or uplink reception; and the transceiver is configured to transmit the first beam information to the repeater.

Yet another aspect of the disclosure provides a base station including a transceiver and a processor coupled to the transceiver, wherein the transceiver is configured to transmit a plurality of beam information to a repeater; and the processor is configured to determine a mapping relationship and/or a grouping relationship between the plurality of beam information.

The disclosure provides a method and device for receiving and transmitting information/signals, which can improve the performance of a Network-Controlled Repeater (NCR).

### Mode for the Invention

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to their bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it can be advantageous to set forth definitions of certain words and phrases used throughout this patent document. The term “couple” and its derivatives refer to any direct or indirect communication between two or more clements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, in-terconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies. In addition, the technical schemes of the embodiments of the application can be applied to future-oriented communication technologies.

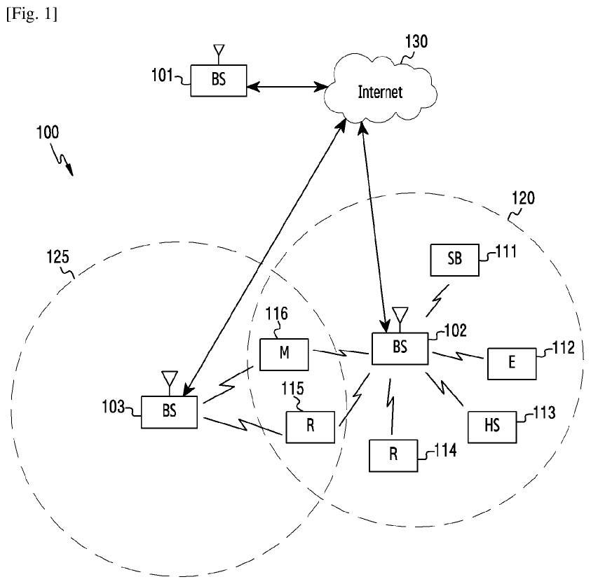

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”. FIG. 1 illustrates an example wireless network 100 according to various embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also com-municates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

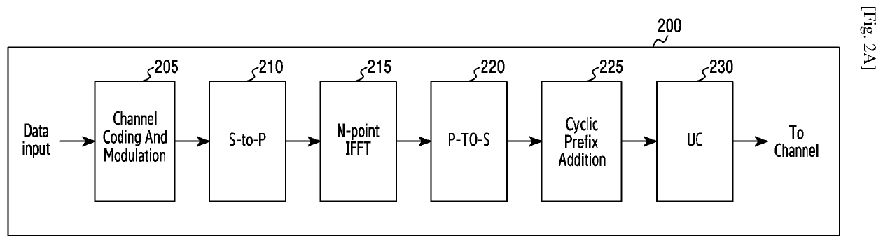

FIG. 2A illustrates example wireless transmission path according to the disclosure. And FIG. 2B illustrates example wireless reception paths according to the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

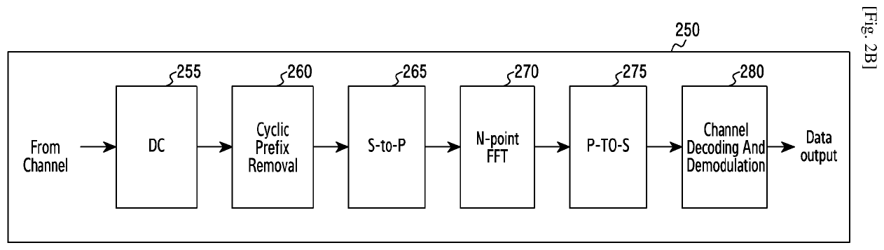

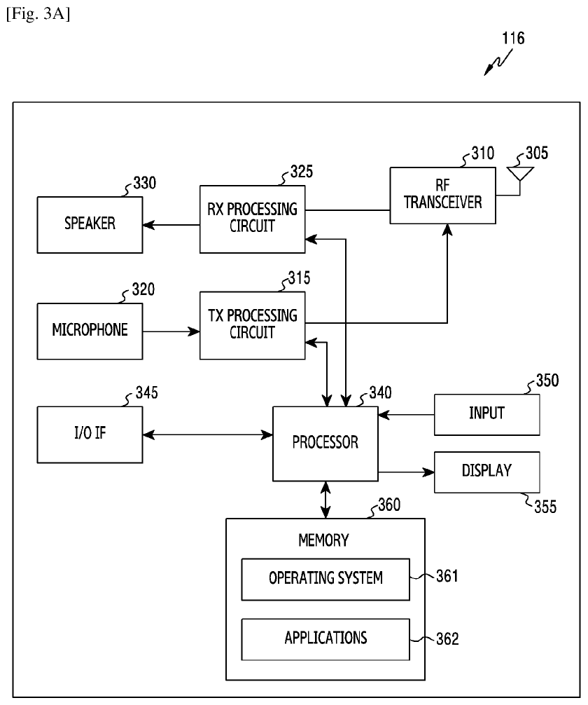

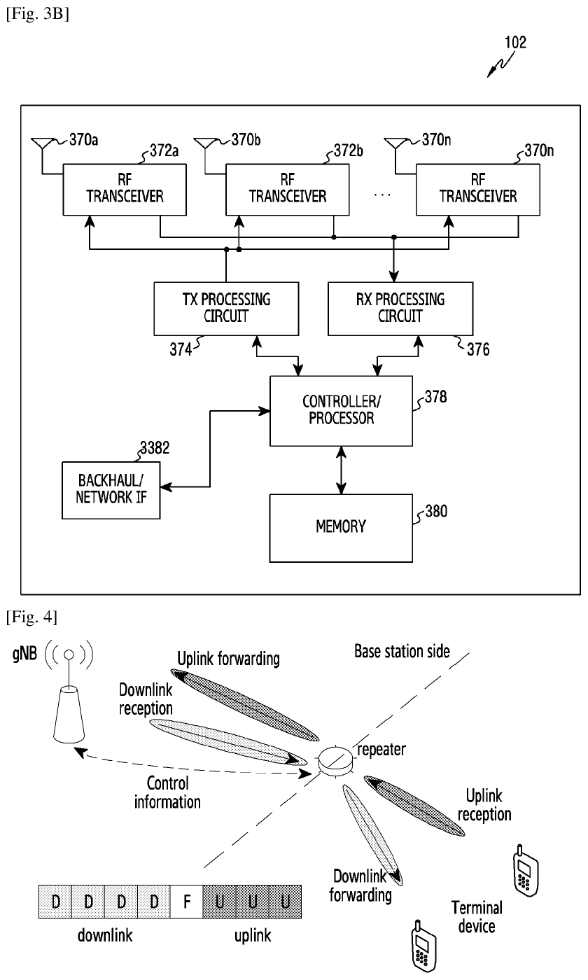

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362. However, the components of the UE 116 are not limited thereto. For example, the UE 116 may include more or fewer components than those described above. In addition, the UE 116 corresponds to the UE of the FIG. 12.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382. However, the components of the gNB 102 are not limited thereto. For example, the gNB 102 may include more or fewer components than those described above. In addition, the gNB 102 corresponds to the base station of the FIG. 13.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In order to enhance the coverage of the 5G wireless communication system, one method is to set up a repeater at the edge of the cell (or the area with poor cell signal coverage). Generally, the repeater is usually divided into two sides, a base station side and a terminal side. FIG. 4 illustrates an example network including an NCR according to various embodiments of the disclosure. As shown in FIG. 4, for the downlink of the base station, the repeater receives radio frequency (RF) signals from the base station. These RF signals pass through a built-in amplifier in the repeater and send the amplified signals to the terminal device at the terminal side of the repeater. For the uplink of the base station, the repeater receives the radio frequency (RF) signals from the terminal device at the terminal side. These RF signals pass through the built-in amplifier in the repeater and send the amplified signals to the base station at the base station side of the repeater.

Generally, the existing repeater cannot be controlled by the base station. That is, the on/off of the repeater, the timing of uplink and downlink forwarding and the direction of uplink and downlink forwarding are all achieved through techniques implemented by the repeater itself/in a way of manual setting adjustment, which is not beneficial to the flexibility of network distribution and the coverage of the repeater. In order to overcome the above shortcomings, one solution is to integrate a terminal device for the repeater, which can communicate with network devices (e.g., base stations) in order to flexibly control the repeater. Such a repeater integrated with the terminal device is called a network-controlled repeater, the NCR.

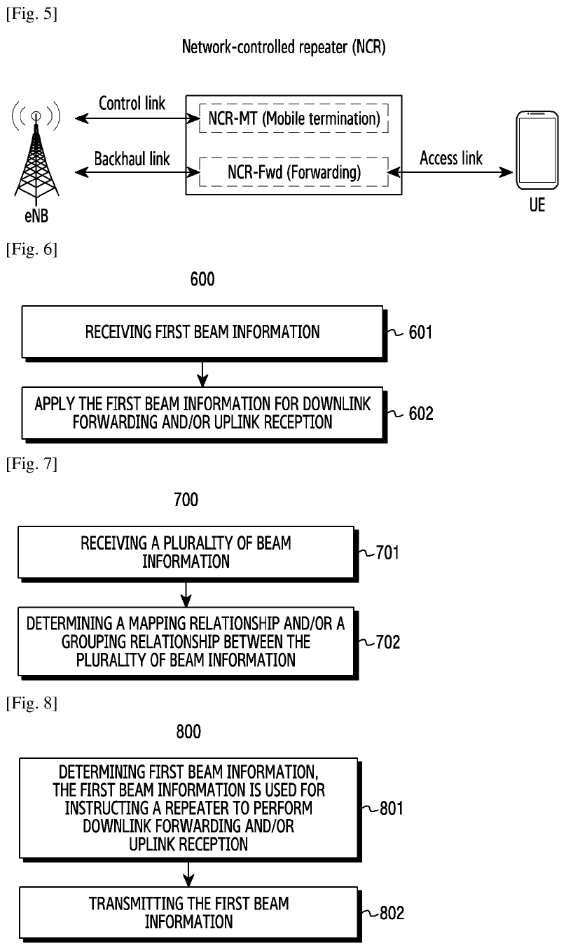

FIG. 5 illustrates an example structure of the NCR according to various embodiments of the present disclosure. As shown in FIG. 5, the NCR has two functional entities: a first unit and a second unit. It can be understood that in this disclosure, the repeater (NCR) and the naming thereof are only exemplary and not limiting. Particularly, in this disclosure, take the network-controlled repeater mobile terminal (NCR-MT) as an example of the first unit, and the network-controlled repeater forwarder (NCR-Fwd) as an example of the second unit, in which:
The NCR-MT is defined as a functional entity for information exchange (for example, side control information) with the base station. Here, the link between the NCR-MT and the base station is called a control link (C-link). In addition, the side control information is at least used to control the NCR-Fwd.
The NCR-Fwd is defined as a functional entity for amplifying and forwarding radio frequency signals (e.g., uplink/downlink radio frequency signals) between the base station and a UE. The link between the NCR-Fwd and the base station is called a backhaul link; and the link between the NCR-Fwd and the UE is called an access link.

In this disclosure, the NCR can refer to NCR-MT or NCR-Fwd, or a combination of both. Optionally, the NCR-MT can also be equivalently understood as a UE, that is, it can be equivalently understood as a terminal device (UE).

In order to avoid ambiguity, corresponding names are defined here for transmission and reception behaviors of the repeater. Referring back to FIG. 4, for the NCR, or for the NCR-Fwd, radio frequency signal reception for downlink (or radio frequency signal reception at the base station side; or radio frequency signal reception on the backhaul link) is called downlink reception; radio frequency signal transmission for downlink (or radio frequency signal transmission at the terminal side; or radio frequency signal forwarding to the terminal; or radio frequency signal transmission on the access link) is called downlink forwarding; radio frequency signal reception for uplink (or radio frequency signal reception at the terminal side; or radio frequency signal reception on the access link) is called uplink reception; radio frequency signal transmission for uplink (or radio frequency signal transmission at the base station side; or radio frequency signal forwarding to the base station; or radio frequency signal transmission on the backhaul link) is called uplink forwarding.

The current NCR has the following problems:
#1. At present, there is no method to indicate the beam used by the NCR-Fwd for downlink forwarding and/or uplink reception, which means that the beam for the NCR-Fwd for downlink forwarding and/or uplink reception cannot be adjusted in time by the base station, which leads to link quality degradation of the access link and poor coverage capability of the NCR, thus resulting in performance degradation of the communication system.
#2. At present, there is no method to indicate/determine the beam characteristics of the NCR-Fwd (for example, the width relationship between beams, a plurality of beams being on the same or different panels, etc.). This means that the relationship between beams of different NCR-Fwd (for example, whether the widths between beams are the same or not, and whether beams share a panel) is unknown. This makes it impossible for the base station to use this information to indicate the beam for the NCR-Fwd. As a result, the quality of the access link is degraded, the coverage capability of the NCR is affected, therefore the performance of the communication system is degraded.

In order to solve at least one of the above problems, this disclosure proposes a number of methods. On the one hand, the beam used by the NCR-Fwd for downlink forwarding and/or uplink reception can be indicated, and on the other hand, the characteristics between NCR-Fwd beams can be characterized by providing the mapping relationship or grouping relationship between the beam information of the NCR-Fwd. These methods can avoid the problems of vague beam indication and/or unclear beam feature of the NCR, so as to improve the link quality between the NCR and UEs, improve the reliability of the NCR and the performance of the communication system. This will be described in detail below through specific embodiments and examples.

### Embodiment 1 (NCR-Fwd Beam Indication)

FIG. 6 illustrates a method 600 performed by the NCR according to embodiments of the disclosure. The method 600 includes: in step 601, NCR receivers first beam information; in step 602, NCR uses the first beam information for downlink forwarding and/or uplink reception.

Optionally, the NCR receives the first beam information from a base station. Optionally, the first beam information is indicated by indication signaling (for example, RRC, MAC CE or DCI) from the base station. Here, the NCR may be understood as the NCR-MT.

The NCR uses the first beam information; wherein the first beam information is used for downlink forwarding and/or uplink reception. In other words, the NCR-Fwd of the NCR applies (or uses) the first beam information for downlink forwarding and/or uplink reception. Here, it may also be understood that NCR determines and/or adjusts the beam used by the NCR-Fwd for downlink forwarding and/or uplink reception according to the first beam information received by the NCR-MT. In this disclosure, the beam may be understood as a (downlink forwarding/uplink reception) spatial filter.

Optionally, the first beam information includes at least one of the followings:
A beam ID. Here, the NCR performs at least one of the following operations:
#1. The NCR-Fwd uses a beam ID (associated/corresponding beam) for downlink forwarding. For example, the NCR-Fwd uses the beam ID (related/corresponding spatial filter) for downlink forwarding.
#2. The NCR-Fwd uses a beam ID (associated/corresponding beam) for uplink reception. For example, the NCR-Fwd applies the beam ID (related/corresponding spatial filter) for downlink forwarding.

It can be understood that when the beam ID in #1 and #2 is the same, the beam used in #1 and #2 is the same. That is, the NCR-Fwd can use the same beam (spatial filter) for downlink forwarding and uplink reception at respective times. In general, the NCR-Fwd cannot use the same beam (spatial filter) for downlink forwarding and uplink reception at the same time. Similar descriptions below should also be similarly understood.
Reference signal information (e.g., reference signal ID, and the following description of the example takes reference signal ID as an example). Here, the type of the reference signal may be at least one of an SSB, a CSI-RS and an SRS. Here, the NCR performs at least one of the following operations:
#1. The NCR-Fwd uses a reference signal ID (related/corresponding beam) for downlink forwarding.
#2. The NCR-Fwd uses a reference signal ID (related/corresponding beam) for uplink reception.

It may be understood that when the reference signal in #1 and #2 is the same (that is, the reference signals have the same ID and their corresponding reference signal types are also the same), the beam used in #1 and #2 is the same.

In this application, the beam ID may be associated with the reference signal ID (corresponding to the following Method 1) and may also not be associated with the reference signal ID (corresponding to the following Method 2). The specific methods are as follows:

### Method 1

The NCR performs at least one of the following operations:
#1. When the beam ID is associated with the reference signal ID, the NCR-Fwd uses the reference signal ID (related/corresponding spatial filter) for downlink forwarding (similar to the above-mentioned case with only the reference signal ID).
#2. When the beam ID is associated with the reference signal ID, the NCR-Fwd uses the reference signal ID (related/corresponding spatial filter) for uplink reception (similar to the above-mentioned case with only the reference signal ID).

It may be understood that when the beam ID in #1 and #2 is the same, the beam used in #1 and #2 is the same.

### Method 2

The NCR performs at least one of the following operations:
#1. When the beam ID is not associated with the reference signal ID, the NCR uses the beam ID (related/corresponding spatial filter) for downlink forwarding (similar to the above-mentioned case with only the beam ID).
#2. When the beam ID is not associated with the reference signal ID, the NCR uses the beam ID (related/corresponding spatial filter) for uplink reception (similar to the above-mentioned case with only the beam ID).

It may be understood that when the beam ID in #1 and #2 is the same, the beam used in #1 and #2 is the same.
A Transmission Configuration Indication (TCI) status ID. Here, the TCI state may be a Unified TCI state. For example, a downlink TCI state, an uplink TCI state or a joint TCI state. The NCR performs at least one of the following operations:
#1. The NCR uses the (reference signal corresponding to) TCI state ID (related/corresponding spatial filter) for downlink forwarding. For example, the NCR uses the (reference signal corresponding to) TCI state ID (related/corresponding spatial filter) for downlink forwarding. For example, the NCR uses the (reference signal corresponding to) TCI state ID (related/corresponding spatial filter) for downlink forwarding. For example, the NCR uses the (reference signal corresponding to) TCI state ID (related/corresponding spatial filter) for downlink forwarding.
#2. The NCR uses the (reference signal corresponding to) TCI state ID (related/corresponding spatial filter) for uplink reception. For example, the NCR uses the (reference signal corresponding to) TCI state ID (related/corresponding spatial filter) for uplink reception. For example, the NCR uses the (reference signal corresponding to) TCI state ID (related/corresponding spatial filter) for uplink reception. For example, the NCR uses the (reference signal corresponding to) TCI state ID (related/corresponding spatial filter) for uplink reception.

It may be understood that when the TCI state ID in #1 and #2 is the same, the beam used in #1 and #2 is the same.
A Panel ID. This information may be combined with the beam information above. Taking the combination with beam ID as an example, apart from combinations with other beam information. The NCR performs at least one of the following operations:
#1. The NCR uses a panel ID (on the corresponding panel, specifically, for an NCR-Fwd, one or more antenna panels may be adopted for access link transmitting and/or receiving) and beam ID (related/corresponding spatial filter) for downlink forwarding.
#2. The NCR uses a panel ID (on the corresponding panel) and a beam ID (related/corresponding spatial filter) for uplink reception.

It may be understood that when the panel IDs and beam IDs in #1 and #2 are the same, the spatial filters used in #1 and #2 are the same. Optionally, when the NCR-Fwd uses two (different) beam information (e.g., beam IDs) at the same time, the panel IDs corresponding to these beam information (e.g., beam IDs) are different.

In Embodiment 1, the reference signal corresponding to the TCI state ID refers to a Quasi-Co-Location (QCL) type D reference signal corresponding to the TCI state (for example, the DL TCI state or the joint TCI state); or refers to an SRS reference signal associated with the TCI state (for example, the UL TCI state).

In Embodiment 1, the spatial filter related to the reference signal information (reference signal ID) refers to the (downlink forwarding/uplink reception) spatial filter used by the NCR-Fwd on the time domain resources (e.g., symbol/time slot where the reference signal is located) corresponding to the reference signal information (reference signal ID). Optionally, the downlink forwarding spatial filter is used to describe the case where the reference signal is an SSB or a CSI-RS. Optionally, the uplink reception spatial filter is used to describe the case where the reference signal is an SRS.

In this embodiment, a CSI-RS ID may be understood as a CSI-RS resource ID. An SRS ID may be understood as an SRS resource ID.

In Embodiment 1, the first beam information corresponds to at least one of the followings:
A cell. For example, a (serving) cell with the lowest ID. For example, a (serving) cell with the lowest ID in a frequency band. Optionally, the frequency band refers to the frequency band corresponding to the NCR-Fwd, PCell/PSCell/SpCell, or the cell with the ID indicated by the base station (indicating signaling).
A bandwidth part (BWP). For example, an active BWP, a BWP with the lowest ID, an initial BWP, and a BWP with the ID indicated by the base station (e.g., indicating signaling). Optionally, the BWP refers to an uplink BWP and/or a downlink BWP.

When the first beam information is different from the second beam information indicated by the NCR before receiving the first beam information (for example, the second beam information received from the base station), the NCR determines to apply the first beam information for downlink forwarding and/or uplink reception. In other words, if the NCR receives a plurality of beam information from the base station, the NCR applies/uses the most recently received beam information among the plurality of beam information for downlink forwarding and/or uplink reception. Taking the beam ID as an example, the NCR received an indication message with a beam ID of 0, and before that, the NCR received an indication message with a beam ID of 1. Because these two messages are different (the beam IDs are different), the NCR performs uplink reception and/or downlink forwarding according to the indication message with a beam ID of 0 (the latest indication message).

The following is a description of the application time point of the first beam information (when the above conditions are satisfied, i.e., when the first beam information is different from the second beam information indicated by the NCR before receiving the first beam information).

#1. The NCR applies the first beam information (or uses the beam corresponding to the first beam information) for downlink forwarding and/or uplink reception after transmitting a signal (or channel) carrying the feedback for the first beam information for a predefined time. That is, the NCR applies the first beam information after transmitting the channel (e.g., a PUCCH or PUSCH) carrying the feedback (e.g., HARQ-ACK) corresponding to the first beam information for a predefined time. Optionally, the NCR applies the first beam information in a first time slot after X1 symbols after the last symbol transmitting the channel (e.g., a PUCCH or PUSCH) carrying feedback (e.g., HARQ-ACK) corresponding to the first beam information. Optionally, X1 refers to the beam information application time. Optionally, length of X1 is a fixed value (for example, 28 symbols), or the length of X1 is determined based on capability (or capability signaling) reported by the NCR.

#2. The NCR applies the first beam information (or uses the beam corresponding to the first beam information) for downlink forwarding and/or uplink reception after receiving a signal or channel carrying the first beam information for a predefined time. That is, the NCR applies the first beam information after receiving the channel (e.g., a PDCCH) carrying the first beam information for a predefined time. Optionally, the NCR applies the first beam information in the first time slot after X2 symbols after the last symbol receiving the channel (e.g., a PDCCH) carrying the first beam information. Optionally, X2 refers to the beam application time. Optionally, length of X2 is a fixed valuc (for example, 28 symbols), or the length of X2 is capability reported by of the NCR.

Apart from applying the beam information for downlink reception and/or uplink forwarding by the above method, the NCR may determine which time domain resources/frequency domain resources to apply (or usc) the beam information and the power (or amplification gain) indicated by the power information corresponding to the beam information. It should be understood that the beam information, time-frequency domain resources and power information here are all indicated by the base station to the NCR, and they are associated with each other. The detailed explanation is as follows.

### EXAMPLE 1 (TIME DOMAIN RESOURCES)

The NCR uses the first beam information for downlink forwarding and/or uplink reception on the time domain resources indicated by the base station and corresponding (related) to the first beam information. Here, application methods for the first beam information can refer to Embodiment 1. Optionally, methods for determining the time domain resources are as follows:

### Method 1 (Periodic Time Domain Resources)

In Method 1, the NCR receives time domain information (e.g., a time domain resource ID) from the base station. The time domain information includes/corresponds to time domain resource information and periodicity information. Optionally, the association between the time domain resource information and periodic information is indicated by RRC.

Optionally, the time domain resource information includes at least one of the followings:
Slot information. Optionally, the time slot information includes at least one of the followings:
The slot information includes one or more slot IDs. For example, the slot information is a slot ID list. The list is indicated by RRC.
Subcarrier spacing (SCS) corresponding to the slot (ID/list). For different frequency ranges, (possible) values corresponding to the SCS are different. For example, when the frequency range is FR1, the SCS is 15 or 30 kHz. When the frequency range is FR2-1, the SCS is 60 or 120 KHz. When the frequency range is FR2-2, the SCS is 120 or 480 kHz. For another example, (optionally, when the SCS corresponding to the slot is not provided) the subcarrier spacing corresponding to the slot (ID/list) may be understood as at least one of the followings:
#1. Reference subcarrier spacing. For example, reference Subcarrier spacing indication (referenceSubcarrierSpacing) in TDD configuration information (tdd-UL-DL-ConfigurationCommon). Furthermore, the TDD configuration information is used for the PCell of the NCR-MT.
#2. Subcarrier spacing of an SSB; further, the SSB is related to the NCR-MT. For example, the subcarrier spacing of the SSB corresponding to the last PRACH transmission of the NCR-MT; for another example, the base station indicates the TCI state of CORESET #0 through MAC-CE signaling, and the SSB corresponds to (is associated with) the TCI state.
#3. Preset subcarrier spacing, for example, 15 kHz, 30 kHz, 60 kHz, 120 kHz, 240 kHz.
#4. Subcarrier spacing corresponding to CORESET #0 of the NCR-MT.
#5. Subcarrier spacing corresponding to initial BWP of the NCR-MT. For example, subCarrierSpacingCommon in MIB.
#6. Subcarrier spacing corresponding to active BWP of the NCR-MT. For example, the subcarrier spacing of active BWP corresponding to the PCell of the NCR or the serving cell with the lowest ID.
Symbol information.
Optionally, the symbol information here refers to the symbol information corresponding to the above (one/each) time slot information (or time slot ID). For example, it indicates one/more/all symbols in the above one time slot. For example, it indicates the first N symbols in the above one time slot, where N may be 1, 2, 3, etc. For example, it indicates the last M symbols in the above one time slot, where M may be 11, 12, 13, etc. The NCR-Fwd uses the beam indicated by beam information on these indicated symbols. For example, the symbol information in one time slot is indicated by a bitmap. Specifically, the bitmap is a 14-bit bitmap, where a first bit indicates a first symbol of the slot, a second bit indicates a second symbol of the slot, and so on.
Offset information.
For example, offset information corresponding to the periodicity information. The terminal device determines position of the time domain resources according to periodicity information and offset information.
A starting position and length of the time domain resources.
Optionally, the starting position information of the time domain resources may be at least one of the slot information, symbol information and offset information.
Optionally, a unit corresponding to the time domain resource length is a second/millisecond/microsecond. Optionally, the unit of the time domain resource length is symbol/slot/sub-frame/frame. For example, if the unit of the time domain resource length is a symbol or a slot, the SCS corresponding to the symbol/slot will be provided accordingly. Or, the SCS corresponding to this symbol/slot is the same as the SCS corresponding to the above time slot (ID/list). Optionally, when the starting position of the time domain resources is a time unit (e.g., starting symbol/starting time slot), the corresponding time domain resource length information refers to the number of the corresponding time units (M) and/or the number of repetitions (R). For example, when the number of time units (M) is provided, the time domain resources refer to consecutive M time units from the starting time unit. For another example, when both the number of time units (M) and the number of repetitions (R) are provided, the time domain resources refer to consecutive M*R time units from the starting time unit (Optionally, when R is not provided, R=1). For another example, when the number of repetitions (R) is provided, the SLIV (or the starting symbol and the number of symbols of each of the R time slots) of consecutive R time slots are the same. Optionally, when the starting position of the time domain resources is provided but the time domain resource length is not provided, the time domain resources are the time units (for example, symbols/slots/subframes/frames) corresponding to the starting position of the time domain resources. For example, the time domain resources are (all symbols of) the starting slot.
Optionally, the starting position of the time domain resources and the time domain resource length refer to the SLIV. For example, the starting position (e.g., the starting symbol) and the length (e.g., the number of symbols) of the time domain resources are determined according to the SLIV.
The starting position of the time domain resources and an ending position of the time domain resources.
Optionally, the starting position information of the time domain resources may be at least one of slot information, symbol information and offset information.
Optionally, the ending position information of the time domain resources may be at least one of slot information, symbol information and offset information.
Reference signal information (for example, at least one of a reference signal ID, a reference signal resource ID, and a reference signal type).
The reference signal refers to a periodic reference signal (for example, SSB or periodic CSI-RS, periodic SRS).
Taking SSB as an example, the above-mentioned time domain resources refer to the time domain resources where SSB is located (for example, the time slot where SSB is located or the symbol where SSB is located). Furthermore, SSB refers to beam sweeping (UE side/access link of the NCR), or the ID of SSB is indicated by the base station through dedicated signaling; or the SSB is determined through an initial access procedure; or the SSB is indicated by MAC-CE signaling.
Taking periodic CSI-RS as an example, the above-mentioned time domain resources refer to the time domain resources where CSI-RS resources are located (for example, the time slot where CSI-RS resources are located or the symbol where CSI-RS resources are located). Furthermore, the CSI-RS refers to beam sweeping (the UE side link/access link of the NCR), or the ID of the CSI-RS resources is indicated by the base station through dedicated signaling.
Channel information.
Specifically, the channel refers to a PRACH, a PDCCH and a PDCCH. In addition, the channel may also refer to a common channel.
Taking PRACH as an example, the time domain resources refer to the time domain resources where the PRACH occasion corresponds to the PRACH (for example, the time slot where the PRACH occasion is located or the symbol where the PRACH is located). Furthermore, the beam indication corresponding to the PRACH occasion may be understood as the SSB (or SSB ID) associated with the PRACH. That is, the NCR applies the same spatial filter as SSB's spatial filter for downlink forwarding on the time domain resources where the PRACH occasion is located. Here, SSB refers to at least one of the followings:
The SSB determined by the NCR-MT according to the initial access procedure.
The SSB determined by the NCR-MT according to the MAC-CE signaling of the base station. The MAC-CE signaling indicates/activates the TCI state corresponding to CORESET #0, and the TCI state and the SSB are QCLed.
The SSB determined by the NCR-MT according to the dedicated signaling of the base station. This dedicated signaling indicates which SSBs NCR forwards, or which SSBs to use for beam sweeping.
The time domain resources corresponding to the SSB are used for downlink forwarding. That is, the NCR performs downlink forwarding on all symbols of the SSB. In other words, the NCR is in ON state on the time domain resources corresponding to the SSB.
Taking the PDCCH as an example, the above-mentioned time domain resources refer to time domain resources (corresponding time slot or corresponding symbol) used for PDCCH monitoring. Furthermore, the time domain resources refer to the time domain resources of search space related to CORESET #0, or the time domain resources refer to the time domain resources related to Common Search Space (CSS). Here, the NCR applies the spatial filter for downlink forwarding corresponding to the TCI state or the reference signal of the QCL assumption (or, in other words, the reference signal of the QCL) corresponding to the time domain resources on the time domain resources monitored by the PDCCH.
Taking PDSCH as an example, the above-mentioned time domain resources refer to the time domain resources (time slot or symbol) where the PDSCH carrying system information is located. For example, the time slot or symbol where the PDSCH scheduled by the PDCCH carrying SIBI and scrambled by SI-RNTI is located.
The time domain resources (for example, RB-set or carrier) corresponding to subband non-overlapped full duplexing (SBFD). Here, SBFD is also called cross full duplex (XDD).
For example, the NCR-Fwd applies the first beam information on the time domain resources corresponding to SBFD for uplink reception and/or downlink forwarding.

Optionally, the periodicity information refers to the periodicity of time domain resources corresponding to the above time domain information. Optionally, the unit of the periodicity is a second/millisecond/microsecond. Taking millisecond as an example, the specific values may be 0.5, 0.625, 1.25, 2, 2.5, 5, 10, 20, 40, 80, 160. Optionally, the unit of the periodicity is a symbol/slot/sub-frame/frame. For example, if the unit of the periodicity is a symbol or a slot, the SCS corresponding to the symbol/slot will be provided accordingly. Or, the SCS corresponding to this symbol/time domain is the same as the SCS corresponding to the slot (ID/list). Optionally, the periodicity information may be obtained by at least one of the following methods:
#1. Base station indication. For example, a value indicating a periodicity (e.g., millisecond/slot and corresponding unit described above). Optionally, the indication is a dedicated indication (e.g., MAC-CE, RRC).
#2. Periodicity of an SSB. For example, the NCR obtains SSB periodicity by receiving ssb-periodicityServingCell. Optionally, when the NCR does not receive the indication in #1, this method is adopted to determine the periodicity.
#3. Periodicity corresponding to the PRACH occasion. For example, the periodicity is determined according to a predefined rule (for example, equal to the SSB periodicity in #2).
#4. Periodicity of a CSI-RS. For example, the periodicity corresponding to a track reference signal (TRS).
#5. Periodicity of the DL-UL pattern. For example, the periodicity provided by dl-UL-Transmissionperiodicity in TDD-UL-DL-ConfigCommon. Optionally, when the NCR does not receive the indication in #1, this method is used to determine the periodicity.

Optionally, for the time domain resources determined by the above Method 1, the NCR receives the indication information from the base station. Optionally, the indication information is used to indicate whether the corresponding beam information/indication is used on the time domain resources (or whether the beam information/indication associated beam is used on/applied to the time domain resources, in other words, whether to use/apply the beam information/indication associated beam for forwarding on the time domain resources). Optionally, the indication information is used to activate/deactivate the beam information and the corresponding time domain resources.

Optionally, the NCR starts to use (on the corresponding time domain resources) the beam information (corresponding to the indication information) in a first time slot (or a first symbol of the first time slot) after X symbols after the last symbol of the PUCCH/PUSCH carrying HARQ-ACK for DCI corresponding to the indication information. Optionally, the SCS corresponding to the X symbols and/or the first time slot (the first symbol of the first time slot) is determined according to the minimum/maximum SCS corresponding to one or more time domain resources corresponding to the indication information. Optionally, the SCS corresponding to the X symbols and/or the first time slot (the first symbol of the first time slot) is determined according to the corresponding minimum/maximum SCS in one or more configured time domain resources.

Optionally, the start of the time domain resources is determined according to the time domain position of the signal or channel carrying the indication information. Optionally, the starting position of the time domain resources is determined according to the time domain position of the signal or channel carrying the feedback (e.g., HARQ-ACK) for the indication information.

Optionally, the indication information is DCI, or the indication information is carried by DCI. Optionally, the DCI is scrambled by CS-RNTI. Optionally, the DCI format corresponding to the DCI is at least one of DCI formats 0_1, 0_2, 1_1 and 1_2. Optionally, the DCI format corresponding to the DCI is dedicated for the NCR.

Optionally, the indication information is MAC-CE, or the indication information is carried by DCI. For example, the information is indicated by a field in the MAC-CE. For example, when the field indicates ‘1’, the corresponding beam information/indication is used on the corresponding time domain resources; when the field indicates ‘0’, the corresponding beam information/indication is not used on the corresponding time domain resources.

Optionally, when the NCR (e.g., the NCR-MT) receives indication information (e.g., MAC-CE command for activating the beam information), and when the NCR would transmit a PUCCH with HARQ-ACK information in slot n corresponding to the PDSCH carrying the activation command, NCR shall use (the assumption of) the beam information on the corresponding time domain resource starting from the first slot that is after slot n+3Nₛₗₒₜ^{subframe,μ} where μ is the SCS configuration for the PUCCH transmission.

Optionally, when the NCR (e.g., the NCR-MT) receives indication information (e.g., MAC-CE command for deactivating the beam information), and when the NCR would transmit a PUCCH with HARQ-ACK information in slot n corresponding to the PDSCH carrying the deactivation command, NCR shall stop to use (the assumption of) the beam information on the corresponding time domain resource starting from the first slot that is after slot n+3Nₛₗₒₜ^{subframe,μ} where μ is the SCS configuration for the PUCCH transmission.

### Method 2 (Aperiodic Time Domain Resources)

In this method, the time domain information (for example, time domain resource ID) includes/corresponds to (optionally, the correspondence between the time domain resource information and the {time domain offset and time domain resource length} is indicated by RRC) at least one of the followings:
Time domain offset (used to determine the starting position of the time domain resources corresponding to time domain information).
The time domain offset can be one of the followings:
#1. The time domain offset refers to the offset between the signal or channel carrying the time domain information and the starting of the time domain resources corresponding to the time domain information.
Optionally, the unit of the time domain offset is a time slot or a symbol;
Optionally, the signal or channel refers to the PDCCH corresponding to the DCI.
#2. The time domain offset refers to the offset between the signal or channel carrying the feedback corresponding to the time domain information and the starting of the time domain resources corresponding to the time domain information.
Optionally, the unit of the time domain offset is a time slot or a symbol;
Optionally, the feedback refers to ACK information, or HARQ-ACK information;
Optionally, the signal or channel refers to a PUCCH or a PUSCH.
#3. The time domain offset refers to the offset between a first time domain position after the signal or channel carrying the time domain information and the start of the time domain resources corresponding to the time domain information.
Optionally, the unit of the time domain offset is a time slot or a symbol or a frame or a sub-frame;
Optionally, the signal or channel refers to the PDCCH corresponding to the DCI;
Optionally, the first time domain position refers to the time domain position which is X time units (e.g., symbols) after a time unit of the signal or channel (e.g., the last symbol of the signal or channel). Here, X is a fixed value or related to capability reported by the NCR. Optionally, X refers to the beam application time; optionally, the SCS for the time unit of X is based on the SCS corresponding to the time domain resources. Optionally, the SCS for the time unit of X is based on the minimum/maximum SCS in the SCSs corresponding to one or more time domain resources cor-responding to the beam indication.
Optionally, the first time domain position refers to a first time unit (e.g., slot) which is X time units (e.g., symbols) after a time unit of the signal or channel. Here, X is a fixed value or related to capability reported by the NCR. Optionally, X refers to the beam application time. In other words, in this method, the time domain offset is with reference to the first time domain position. For example, when the start of the time domain resources is in the slot where the first time domain position are located, the time domain offset is 0. Optionally, the SCS for the time unit of X is based on the SCS corresponding to the time domain resources. Optionally, the SCS for the time unit of X is based on the minimum/maximum SCS in the SCSs corresponding to one or more time domain resources corresponding to the beam indication. Optionally, the SCS for the first time unit is based on the SCS corresponding to the time domain resources. Optionally, the SCS for the first time unit is based on the minimum/maximum SCS in the SCSs corresponding to one or more time domain resources corresponding to the beam indication.
#4. The time domain offset refers to the offset between the first time domain position after the signal or channel carrying the feedback corresponding to the time domain information and the start of the time domain resources corresponding to the time domain information.
Optionally, the unit of the time domain offset is a time slot or a symbol;
Optionally, the signal or channel refers to the PDCCH corresponding to the DCI;
Optionally, the first time domain position refers to the time domain position which is X time units (e.g., symbols) after a time unit of the signal or channel (e.g., the last symbol). Here, X is related to capability reported by the NCR. Optionally, X refers to the beam application time; optionally, the SCS for the time unit of X is based on the SCS corresponding to the time domain resources. Optionally, the SCS for the time unit of X is based on the minimum/maximum SCS in the SCSs corresponding to one or more time domain resources corresponding to the beam indication.
Optionally, the first time domain position refers to the first time unit (e.g., time slot) which is X time units (e.g., symbols) after a time unit of the signal or channel. Here, X is related to capability reported by the NCR. Optionally, X refers to the beam application time. In other words, in this method, the time domain offset is with reference to the position of the first time domain. For example, when the start of the time domain resources is in the time slot where the first time domain position are located, the time domain offset is 0. Optionally, the SCS for the time unit of X is based on the SCS corresponding to the time domain resources. Optionally, the SCS for the time unit of X is based on the minimum/maximum SCS in the SCSs corresponding to one or more time domain resources corresponding to the beam indication. Optionally, the SCS for the time unit of X is based on the minimum/maximum SCS in the SCSs corresponding to one or more configured time domain resources. Optionally, the SCS for the first time unit is based on the SCS corresponding to the time domain resources. Optionally, the SCS for the first time unit is based on the minimum/maximum SCS in the SCSs corresponding to one or more time domain resources corresponding to the beam indication.
Optionally, the time domain offset is determined according to/based on SCS/numerology for time domain resources (i.e., the time domain resources for the beam in-dication).
Optionally, the time domain offset is determined with reference to the time slot/symbol of the time domain resources (i.e., the time domain resources for applying the beam indication).
Indication method of the time domain offset
#1. Base station indication
For example, the above time domain offset is indicated by the base station. The indication signaling is at least one of RRC, MAC-CE or DCI.
#2. Predefined. Specifically, it refers to at least one of the followings:
For example, the time domain offset (default) is 0. For example, when the time domain offset is not indicated by the base station, the time domain offset is 0. For the definition of the time domain offset, refer to the previous description.
Another example is the first time unit (e.g., time slot/symbol) which satisfies the beam application time requirement after the time domain information (or after the channel or signal carrying the time domain information).
For another example, the first time unit (e.g., time slot/symbol) which satisfies the beam application time requirement after the feedback corresponding to the time domain information (or after the channel or signal carrying the feedback corresponding to the time domain information).
For another example, the value of the time domain offset is related to SCS or frequency range (for example, the NCR determines the value of the time domain offset according to SCS or frequency range). For example, the default value of the time domain offset is related to SCS (for example, when SCS=120 kHz, the value of the time domain offset is 2. For another example, when SCS=15 kHz, the value of the time domain offset is 1).
For another example, the value of the time domain offset is related to whether the corresponding time domain resources are used for downlink forwarding or uplink reception (for example, the NCR determines the value of the time domain offset according to whether the corresponding time domain resources are used for downlink forwarding or uplink reception). For example, when the corresponding time domain resources are used for downlink forwarding, the default value of the time domain offset is 2. When the corresponding time domain resources are used for uplink reception, the default value of the time domain offset is 3.
Subcarrier spacing SCS/numerology for (corresponding to) the time domain resources (or the time domain offset/slot offset):
Optionally, the subcarrier spacing/numerology is (explicitly) indicated by the base station.
Optionally, when the subcarrier spacing/numerology is not indicated, the subcarrier spacing/numerology refers to one of the followings (taking subcarrier spacing as an example below):
#1. Reference subcarrier spacing. For example, reference Subcarrier spacing indication (referenceSubcarrierSpacing) in TDD configuration information (tdd-UL-DL-ConfigurationCommon). Furthermore, the TDD configuration information is used for the PCell of the NCR-MT.
#2. The SCS corresponding to the DCI (in other words, SCS (which activates BWP) for receiving/monitoring of the PDCCH corresponding to the DCI). Wherein, the DCI indicates/corresponds to the time domain resources (or indicates that the corresponding beam is applied on the time domain resources).
#3. The SCS of the PUCCH/PUSCH carrying HARQ-ACK corresponding to the DCI. Wherein, the DCI indicates/corresponds to the time domain resources (or indicates that the corresponding beam is applied on the time domain resources).
#4. Subcarrier spacing of an SSB; further, the SSB is related to the NCR-MT. For example, the subcarrier spacing of the SSB corresponding to the last PRACH transmission of the NCR-MT; for another example, the base station indicates the TCI state of CORESET #0 through MAC-CE signaling, and the SSB corresponds to (is associated with) the TCI state.
#5. Preset subcarrier spacing, for example, 15 kHz, 30 kHz, 60 kHz, 120 kHz, 240 kHz.
#6. Subcarrier spacing corresponding to CORESET #0 of the NCR-MT.
#7. Subcarrier spacing corresponding to initial BWP of the NCR-MT. For example, subCarrierSpacingCommon in MIB.
#8. Subcarrier spacing corresponding to the active BWP of the NCR-MT. For example, the subcarrier spacing of the active BWP corresponding to the PCell of the NCR or the serving cell with the lowest ID.
Symbol information.
Optionally, the symbol information is used to determine the position of the starting symbol in a slot/starting slot (for example, the starting slot determined by the time domain offset).
Time domain resource length.
Optionally, the unit corresponding to the time domain resource length may be at least one of a second, a millisecond and a microsecond.
Optionally, the unit of the time domain resource length may be at least one of a symbol, a time slot, a sub-frame and frame. For example, if the unit of the time domain resource length is a symbol or a time slot, the SCS corresponding to the symbol/time slot will be provided accordingly.
Optionally, the time domain resource length may be indicated by at least one of the following methods.
Base station indication
For example, the above time domain resource length is indicated by the base station. The indication signaling is at least one of RRC, MAC-CE or DCI.
Optionally, the time domain resource length is a specific value (for example, 5 time slots).
Optionally, the time domain resource length is infinite long (for example, infinity). This situation may be understood as the NCR-Fwd applies (or keeps applying) the corresponding beam indication after the beam indication (or keeps applying the beam indication until other beam indication).
Optionally, when the start of the time domain resources is a time unit (e.g., starting symbol/starting slot), the corresponding time domain resource length information refers to the number of the corresponding time units (M) and/or repetition number (R). For example, when the number of time units (M) is provided, the time domain resources refer to consecutive M time units from the starting time unit. For another example, when both the number of time units (M) and the number of repetitions (R) are provided, the time domain resources refer to consecutive M*R time units from the starting time unit (Optionally, when R is not provided, R=1). For another example, when the number of repetitions (R) is provided, the SLIVs (or starting symbols and the numbers of symbols) of R consecutive time slots (starting from the starting time slot) are the same. Optionally, when the starting position of the time domain resources is provided but the time domain resource length is not provided, the time domain resources are the time units (for example, symbols/slots/subframes/frames) corresponding to the starting position of the time domain resources. For example, the time domain resources are (all symbols of) the starting slot. Optionally, the starting position of the time domain resources is determined by the above time domain offset. Optionally, when the above time unit is a time slot, M time slots refer to all symbols in the M time slots. Optionally, when the time unit is a symbol, M*R time slots refer to all symbols in M*R time slots.
Predefined
X time units (symbols/slots/sub-frames/milliseconds). For example, X=1. For another example, X is related to capability reported by the NCR.
The start of the time domain resources and the time domain resource length may be jointly indicated. For example, a Starting and Length Indicator Value (SLIV) is used to indicate the starting symbol and duration (e.g., the number of symbols) in a time slot. For example, the starting time slot and duration (e.g., the number of time slots) are indicated by using the SLIV.

It can be understood that the indication for the time domain offset and time domain length may be one or more indications.

Optionally, for the above time domain resources determined according to the beam indication (e.g., Method 1 and/or Method 2), the NCR (for example, the NCR-Fwd) does not expect the time domain resources (or the symbols/slots corresponding to the time domain resources; or any symbols/slots corresponding to the time domain resources) overlap (or partially overlap) with flexible symbols. Optionally, the flexible symbols are determined according to semi-static TDD UL/DL configuration information (e.g., TDD-UL-DL-ConfigCommon, TDD-UL-DL-ConfigDedicated) and/or (dynamic) SFI information (specific for the NCR-Fwd).

Optionally, for the time domain resources determined according to the beam indication (e.g., Method 1 and/or Method 2), the NCR (e.g., the NCR-Fwd) applies/uses corresponding beam information (for downlink forwarding and/or uplink reception) and/or performs forwarding on the time domain resources other than the flexible symbols. Optionally, the flexible symbols are determined according to semi-static TDD UL/DL configuration information (e.g., TDD-UL-DL-ConfigCommon, TDD-UL-DL-ConfigDedicated) and/or (dynamic) SFI information (specific for the NCR-Fwd).

Optionally, for the time domain resources determined according to the beam indication (e.g., Method 1 and/or Method 2), the NCR (e.g., the NCR-Fwd) do not apply beam indication and/or perform forwarding on the overlapping part of the time domain resources and the flexible symbols (or, in other words, in the symbols/time slots where the time domain resources overlap (and/or partially overlap) with the flexible symbols; in other words, in any symbols/time slots where the time domain resources overlap (and/or partially overlap) with the flexible symbols). Optionally, the flexible symbols are determined according to semi-static TDD UL/DL configuration information (e.g., TDD-UL-DL-ConfigCommon, TDD-UL-DL-ConfigDedicated) and/or (dynamic) SFI information (specific for the NCR-Fwd).

As for one of the above-mentioned methods for determining the time domain resources (Method 1 or Method 2), one possible case is that the NCR obtains both beam indication #1 and beam indication #2 for one time domain resource (e.g., time slot/symbol). Wherein beam indication #2 is after beam indication #1. In this case, the NCR uses the beam indication of beam indication #2. Optionally, beam indication #2 being after beam indication #1 means that the PDCCH occasion corresponding to the PDCCH carrying beam indication #2 is after the PDCCH occasion corresponding to the PDCCH carrying beam indication #1.

The advantage of this method is: the base station may change the previous beam indication, increase the flexibility of the NCR-Fwd beam indication and improve the performance of the NCR.

For the above two methods for determining the time domain resources (Method 1 and Method 2), one possible case is that for one time domain resource (e.g., a time slot/symbol), the NCR obtains beam indication #1 through Method 1 and beam indication #2 through Method 2. In this case, the corresponding operation of the NCR is one of the followings:
The NCR applies the beam indication of Method 2;
The NCR prioritize the use of the beam indication of Method 2. For example, if the NCR has the ability to apply (use) beam indication #1 determined by Method 1 and beam indication #2 determined by Method 2 at the same time, then both beam indications are applied (used) at the same time. Otherwise, the NCR applies (uses) beam indication #2 determined by Method 2.

The advantage of this method is: the indication of Method 1 (periodic beam indication) may be changed by the indication of Method 2 (aperiodic beam indication) at the base station, which increases the flexibility of the NCR-Fwd beam indication and improves the performance of the NCR.

For the time domain resources described in the above methods (for example, Method 1 and/or Method 2), one possible case is that a part of the time domain resources is not applicable to the beam indication corresponding to the time domain resources described in the above methods (Method 1 and/or Method 2). The reason is that these time domain resources may contain important signals or channels (for example, indicated by the base station), and beam directions of these channels or signals cannot be easily changed. Therefore, an exceptional method is required, i.e., to prevent the time domain resources of Method 2 from changing the beams corresponding to these important signals or channels. The specific method is as follows:

The NCR does not apply the first beam information on the first time domain resources for downlink forwarding and/or uplink reception. Wherein the first time domain resources refer to a part of the time domain resources corresponding to the first beam information and refer to the time domain resources used for the time domain resources of the signal or channel indicated by the base station or the time domain resources indicated by the base station. Optionally, the signal or channel refers to a common signal or channel. Here, for the explanation of the signal or channel, refer to the explanation of reference signal information (the reference signal corresponding to the reference signal information) and channel information (the channel corresponding to channel information) in Method 1. Optionally, the time domain resources indicated by the base station refer to the time domain resource position (e.g., starting position and/or length) indicated by the base station.

The advantage of this method is: the base station may avoid changing the beam indication of important signals in an exceptional manner, increase the reliability and/or flexibility of the NCR-Fwd beam indication, and improve the performance of the NCR.

### EXAMPLE 2 (FREQUENCY DOMAIN RESOURCES)

The NCR-Fwd uses the first beam information on the frequency domain resources indicated by the base station and corresponding to the first beam information for downlink forwarding and/or uplink reception. Here, the use of the method of the first beam information is explained in the previous part of Embodiment 1. Optionally, the identifier of the frequency domain resources is the frequency domain resource ID. Optionally, frequency domain resources refer to at least one of the followings:
Frequency range
For example, frequency domain resources refer to frequency range 2, frequency range 2-1 or frequency range 2-2;
For example, frequency domain resources refer to the corresponding (or operating) frequency range of the NCR-MT. That is, the NCR-Fwd applies the first beam information in the corresponding NCR-MT (or operating) frequency range.
Frequency band
For example, the base station indicates the frequency band (e.g., frequency band ID) used by the NCR for downlink forwarding and/or uplink forwarding, and provides the first beam information corresponding to each frequency band. The NCR applies the first beam information on the indicated frequency band correspondingly;
For example, frequency domain resources refer to the frequency band corresponding to the NCR-MT. That is, the NCR-Fwd applies the first beam information in the operating frequency band of the NCR-MT.
Frequency domain resources (for example, RB-set or carrier) corresponding to Subband Non-Overlapping Full Duplexing (SBFD). Here, SBFD can be also called cross full duplex (XDD).
For example, the NCR-MT obtains frequency domain resources corresponding to SBFD. The NCR-Fwd applies the first beam information on these frequency domain resources for uplink reception and/or downlink forwarding. Optionally, the NCR-Fwd uses the first beam information on the time domain resources corresponding to SBFD for uplink reception and/or downlink forwarding.
Carrier (e.g., component carrier).
For example, the base station indicates the carrier used by the NCR for downlink forwarding and/or uplink forwarding, and provides the first beam indication information corresponding to each carrier. The NCR uses the corresponding first beam indication on the carrier;
For example, the carrier corresponding to the NCR-MT (or the carrier used by the NCR-MT). The NCR uses the corresponding first beam information on the carrier corresponding to the NCR-MT.
Channel bandwidth of the NCR-MT.
For example, the NCR-MT obtains channel bandwidth information. The NCR uses the first beam information on the channel bandwidth indicated by the channel bandwidth information.
BWP of the NCR-MT
For example, the NCR uses the first beam information on the active BWP/initial BWP of the NCR-MT.

### EXAMPLE 3 (POWER)

The NCR obtains power information corresponding to the first beam information and indicated by the base station; and uses the power information for downlink forwarding and/or uplink reception (using power corresponding to the power information). Here, the application method of the first beam information is explained in the previous part of Embodiment 1. Optionally, the power information refers to an amplification gain of the NCR-Fwd.

Optionally, if the beam information corresponds to the beam information for downlink forwarding, the amplification gain correspondingly refers to the amplification gain of the NCR-Fwd for downlink (for example, the amplification gain between a downlink received signal and a corresponding downlink forwarded signal).

Optionally, if the beam information corresponds to the beam information for uplink reception, the amplification gain correspondingly refers to the amplification gain of the NCR-Fwd for uplink (for example, the amplification gain between the uplink received signal and the corresponding uplink forwarded signal).

Optionally, if the beam information corresponds to the beam information for uplink reception and downlink forwarding, the amplification gain refers to the amplification gain of the NCR-Fwd for uplink and downlink accordingly. Optionally, the corresponding uplink gain and downlink gain are the same.

The following takes the beam information being the beam information for downlink forwarding as an example.

For example, the beam information received by the NCR for downlink forwarding is beam #1, wherein the downlink amplification gain #0 corresponds to beam #1 (for example, the downlink amplification gain with a value of 0). In this case, the amplification gain of the downlink corresponding to the NCR-Fwd is the lowest (it may also be understood that NCR-Fwd does not perform downlink forwarding; or that NCR-Fwd is OFF).

For example, the beam information received by the NCR for downlink forwarding is beam #1, wherein the downlink amplification gain #1 corresponds to beam #1 (downlink amplification gain with a value of 1). In this case, the NCR-Fwd applies/uses an amplification gain corresponding to amplification gain #1 for downlink forwarding.

For example, the beam information received by the NCR for downlink forwarding is beam #1, wherein the downlink amplification gain #max corresponds to beam #1 (for example, the maximum downlink amplification gain). In this case, the amplification gain of the downlink corresponding to the NCR-Fwd is the maximum amplification gain. In other words, in this case, the NCR-Fwd applies/uses the maximum output power (or the maximum output power corresponding to the first beam information) for downlink forwarding.

It may be understood that the above examples (Example 1, Example 2, Example 3) may be arbitrarily combined.

For Embodiment 1, optionally, various methods described in Embodiment 1 and its examples can be performed only when the NCR satisfies at least one of the following conditions:
The NCR-MT of the NCR and NCR-Fwd of the NCR operate in the same frequency range;
The NCR-MT of the NCR and NCR-Fwd of the NCR operate in the same frequency band;
The NCR-MT of the NCR operates in the passband of the NCR-Fwd of the NCR;
The NCR-MT of the NCR is provided with at least one TCI state; wherein, the TCI state includes a QCL type D reference signal;
The NCR-MT of the NCR is in RRC connection state;
The NCR (including NCR-Fwd and NCR-MT) operates in FR2.

Advantageous effects of Embodiment 1: Embodiment 1 provides a beam indication method for the NCR-Fwd. The method can indicate the beam information corresponding to the NCR-Fwd, so that the base station can control the receiving beam/transmitting beam corresponding to the access link of the NCR-Fwd, thereby improving the link quality of the access link and the performance of the communication system.

### Embodiment 1A (NCR-Fwd Indication Signaling-DCI Format)

The NCR-MT obtains a time domain information set from a base station; the NCR-MT determines a size of a field of downlink control information DCI format based on the time domain information set. Optionally, the field of the DCI format includes at least one of the followings: a beam information field; a switch field; an uplink and downlink field; a time domain resource field. Optionally, the NCR-MT monitors the DCI format.

Optionally, the DCI format is a DCI format for controlling the NCR-Fwd.

Detailed descriptions are as follows:

Optionally, the NCR obtains a time domain information set. For example, the time domain information set is a time domain information list. For another example, the time domain information set is a time domain information list configured by RRC signaling.

Optionally, the time domain information set includes one or more time domain information. For example, the time domain information set includes one or more time domain information entries.

Optionally, the time domain information includes one or more time domain resource indications. For example, the time domain assignment TimeDomainAssignment #1.

Optionally, the NCR-MT monitors the DCI format; wherein the DCI format is used for controlling the NCR-Fwd. Optionally, the NCR-MT monitoring the DCI format means the NCR-MT monitoring a PDCCH (or, optionally, a PDCCH candidate) corresponding to the DCI format.

The field of the DCI format may be understood as a time domain resource field. Optionally, the DCI format includes the time domain resource field. Optionally, the size of the time domain resource field of the DCI format is determined according to the number of time domain information (N) in the time domain information set. Optionally, the size of the time domain resource field is ┌log2(N)┐.

The field of the DCI format may be understood as a beam information field. Optionally, the DCI format includes the beam information field. Optionally, the size of the beam information field of the DCI format is determined according to the maximum number of the time domain resource indications (M) corresponding to one or more time domain information in the time domain information set. Optionally, the size of the beam information field is M*┌log2(N_{beam})┐. Optionally, N_{beam} refers to the number of beam indexes. Optionally, the size of the beam information field is ┌log2(N_{beam})┐. Optionally, N_{beam} refers to the number of beam indexes. Optionally, N_{beam} refers to the number of beam index combinations.

The field of the DCI format may be understood as a first field. Optionally, the DCI format includes the first field; wherein the first field is used for indicating beam index or OFF. Optionally, the size of the first field of the DCI format is determined according to the total number of the time domain resource indications (M) corresponding to one or more time domain information in the time domain information set. Optionally, the size of the first field is M*┌log2(N_{beam}+1)┐. Optionally, the size of the first field is ┌log2(N_{beam}+1)┐. Optionally, N_{beam} refers to the number of beam indexes. Optionally, N_{beam} refers to the number of beam index combinations.

The field of the DCI format may be understood as an uplink and downlink field. Optionally, the DCI format includes the uplink and downlink field. For example, this field is used to indicate the NCR-Fwd to perform downlink reception and/or forwarding on the corresponding time domain resources, or to instruct the NCR-Fwd to perform uplink reception and/or forwarding on the corresponding time domain resources. For another example, the field indicates that the corresponding time domain resources are used for NCR-Fwd downlink reception and/or forwarding, or the field indicates that the corresponding time domain resources are used for NCR-Fwd uplink reception and/or forwarding. Optionally, the size of the uplink and downlink field in the DCI format is determined according to the maximum number of the time domain resource indications (M) corresponding to one or more time domain information in the time domain information set. Optionally, the size of the uplink and downlink field is M.

The field of the DCI format may be understood as a switch field. Optionally, the DCI format includes the switch field. For example, this field is used to indicate whether the NCR-Fwd is ON or OFF (in other words, reception and/or forwarding is performed or not). Optionally, the size of the switch field of the DCI format is determined according to the maximum number of the time domain resource indications (M) corresponding to one or more time domain information in the time domain information set. Optionally, the size of the switch field is M.

The field of the DCI format may be understood as a second field. Optionally, the DCI format includes the second field; wherein the second field is used for indicating uplink/downlink or OFF. Optionally, the size of the second field in the DCI format is determined according to the maximum number of the time domain resource indications (M) corresponding to one or more time domain information in the time domain information set. Optionally, the size of the switch field is 2*M.

The following is explained by examples. The NCR-MT receives time domain resource configuration information (or, a time domain resource configuration list). The configuration information contains five entries, and each entry contains one time domain resource information. In addition, each of the five time domain resource information further includes one or more time domain resource indications (or time domain resource allocations). The details are as follows:
Entry #1. (3 time domain resource indications)
TimcDomainAssignment #1; TimeDomainAssignment #2;
TimeDomainAssignment #3.
Entry #2. (4 time domain resource indications)
TimcDomainAssignment #1; TimeDomainAssignment #2;
TimeDomainAssignment #3; TimeDomainAssignment #4.
Entry #3. (2 time domain resource indications)
TimeDomainAssignment #1; TimeDomainAssignment #2;
Entry #4. (2 time domain resource indications)
TimeDomainAssignment #1; TimeDomainAssignment #2;
Entry #5. (1 time domain resource indication)
TimeDomainAssignment #1;

The NCR-MT monitors the DCI format, and this DCI format is used to control the NCR-Fwd. Wherein the downlink control information includes a time domain resource field. This time domain resource field is used to indicate the time domain resource information entry used/applied by the NCR (or NCR-Fwd). According to the number of time domain resource information entries in the above configuration information (N=5), it can be determined that the size of the time domain resource field is log2(N) rounded up, that is, 3 bits.

Optionally, the DCI format includes a beam information field. Optionally, the beam information field is used to indicate the beam index. For a time domain resource indication, the number of bits in the corresponding beam information field is ┌log2(N_{beam})┐ Further, according to the time domain resource configuration information, there may be at most M time domain resource indications, so the size of the beam information field is M*┌log2(N_{beam})┐. It should be noted that if the number of time domain resource indications corresponding to all time domain resource information (or entries) is 1, then M=1. Optionally, the size of the beam information field is ┌log2(N_{beam})┐. In combination with the above example, N_{beam} being equal to 8 is taken as an example, which corresponds to 3 bits. For the configured 5 entries, the maximum number of time domain resource indications M is 4. Therefore, the total size of the beam information field is 4*3=12 bits. Every 3 bits corresponds to one time domain resource indication. Specifically, when entry #2 is indicated, the first 3 bits of the beam information field correspond to TimeDomainAssignment #1; the last 3 bits of the beam information field correspond to TimeDomainAssignment #2, and so on.

It should be noted that N_{beam} may be understood as the number (or total number) of beams (or beam indexes). For example, for downlink forwarding (or uplink reception) of the NCR-Fwd, there are a total of N_{beam} beams for beam indication (this number may be configured by the base station or reported by the NCR). For another example, N_{beam} may be the sum of NA and NB. Where, NA and NB refer to the number of wide beams and the number of narrow beams, respectively; or, NA and NB refer to the number of SSB beams and the number of CSI-RS beams, respectively.

In addition, N_{beam} may also be understood as the number of beam combinations (or beam index combinations).
Optionally, N_{beam} is related to at least one of the (maximum) number of simultaneous/parallel transmission beams/spatial filters (Nₛᵢₘᵤₗ), the (maximum) number of configured simultaneous/parallel transmission beams/spatial filters (N_{simul, config}), and Nₜₒₜₐₗ. Optionally, Nₛᵢₘᵤₗ is reported by the NCR (for example, through capability reporting information). Optionally, this parameter (N_{simul, config}) is configured by the base station. Optionally, Nₜₒₜₐₗ may be understood as the number (or total number) of beams (or beam index). For example,

$${N}_{beam} = {\sum }_{n = 1}^{{N}_{simul}} ( \begin{matrix}{N}_{total} \\ n\end{matrix} ) .$$

For another example,

$${N}_{beam} = {\sum }_{n = 1}^{{N}_{simul , config}} ( \begin{matrix}{N}_{total} \\ n\end{matrix} ) .$$

For another example,

$${N}_{beam} = {\sum }_{n = 1}^{min ( {N}_{simul} , {N}_{simul , config} )} ( \begin{matrix}{N}_{total} \\ n\end{matrix} ) .$$

For another example,

$${N}_{beam} = {\sum }_{n = 1}^{{N}_{total}} ( \begin{matrix}{N}_{total} \\ n\end{matrix} ) .$$

For another example,

$${N}_{beam} = {\sum }_{n = 1}^{min ( {N}_{tota1} , {N}_{simul , config} )} ( \begin{matrix}{N}_{total} \\ n\end{matrix} ) .$$

Optionally, N_{beam} is related to beam grouping information. For example, N_{beam} is related to Π_{g=1}^{G}N_{g}; wherein N_{g} refers to the number of corresponding beams in a group; G is the number of groups (for example, 1,2,3,4). For example, N₁ refers to the number of beams in a first group; N₂ refers to the number of beams in a second group, and so on. Take G=2 as an example, N_{beam}=N₁+N₂+N₁N₂. Optionally, the number of beam groups is equal to the total number of beams, that is Σ_{g=1}^{G}N_{g}=Nₜₒₜₐₗ. Take G=2 as an example, Nₜₒₜₐₗ=N₁+N₂. Here, for the definition of Nₜₒₜₐₗ, refer to the above. The specific beam grouping method and corresponding explanation are shown in Embodiment 2.

Optionally, the downlink control information includes a first field; wherein the first field is used for indicating beam index or OFF. One of codepoints in the first field is used to indicate OFF, i.e, to indicate that the NCR-Fwd is OFF (in other words, the NCR-Fwd does not receive and/or forward). In this case, for a time domain resource indication, the number of bits in the corresponding beam information field is ┌log2(N_{beam}+1)┐. Further, according to the above time domain resource configuration information, there may be at most M time domain resource indications, so the size of the beam information field is M*┌log2(N_{beam}+1)┐. It should be noted that if the number of time domain resource indications corresponding to all time domain resource information (or entries) is 1, then M=1. Optionally, the size of the beam information field is ┌log2(N_{beam})┐. In combination with the above example, it is further explained that the total number of beam indexes N_{beam} is equal to 8, that is, it corresponds to 4 bits. For the configured 5 entries, the number of maximum time domain resource indications M is 4. Therefore, the total size of the beam information field is 4*4=16 bits. Every 4 bits corresponds to one time domain resource indication. Specifically, when entry #2 is indicated, the first 4 bits of the beam information field correspond to TimeDomainAssignment #1; the last four bits of the beam information field correspond to TimeDomainAssignment #2, and so on. Here, for the explanation of N_{beam}, refer to the previous description.

Optionally, the DCI format includes an uplink or downlink field. Optionally, the size of the uplink or downlink field in the DCI format is determined according to the maximum number of the time domain resource indications (M) corresponding to one or more time domain information in the time domain information set. For one time domain resource indication, it is either for uplink or for downlink. Therefore, the uplink or downlink indication bit corresponding to one time domain resource indications is 1 bit. Further, according to the above time domain resource configuration information, there may be at most M time domain resource indications, so the size of the uplink and downlink field is M. In combination with the above example, it is further explained that for the configured 5 entries, the maximum number of time domain resource indications M is 4. Therefore, the total size of the uplink or downlink field is 4 bits. Each bit corresponds to a time domain resource indication. Optionally, when entry #2 is indicated, the first bit of the uplink and downlink field corresponds to TimeDomainAssignment #1; the second bit of the uplink and downlink field corresponds to TimeDomainAssignment #2, and so on.

Optionally, when the NCR-MT detects/receives the above DCI format, and one time domain resource indications (for example, TimeDomainAssignment #1) corresponds to one Downlink Indication (DL) and one beam index indication (beam beam #1), it may be understood as follows:

### Method 1

The NCR-Fwd applies/uses the corresponding beam indication (or the spatial filter corresponding to the corresponding beam index) in the downlink symbol in TimeDo-mainAssignment #1 (for example, the downlink symbol determined according to semi-static configuration information) for downlink forwarding.

### Method 2

The flexible symbol of the NCR-Fwd in TimeDomainAssignment #1 (for example, the flexible symbol determined according to semi-static configuration information) applies/uses corresponding beam indication (or the spatial filter corresponding to respective beam index) for downlink forwarding.

### Method 3

The downlink and flexible symbols of the NCR-Fwd in TimeDomainAssignment #1 (e.g., downlink and flexible symbols determined according to semi-static configuration information) apply/use corresponding beam indication (or the spatial filter corresponding to respective beam index) for downlink forwarding.

Optionally, when the NCR-MT detects/receives the above DCI format, and one time domain resource indications (for example, TimeDomainAssignment #1) corresponds to an Uplink Indication (UL) and a beam index indication (beam #1), it may be understood as follows:

### Method 1

The uplink symbol (e.g., the uplink symbol determined according to semi-static configuration information) of the NCR-Fwd in TimeDomainAssignment #1 applies/uses corresponding beam indication (or the spatial filter corresponding to respective beam index) for uplink reception.

### Method 2

The flexible symbol of the NCR-Fwd in TimeDomainAssignment #1 (for example, the flexible symbol determined according to semi-static configuration information) applies/uses corresponding beam indication (or spatial filter corresponding to respective beam index) for uplink reception.

### Method 3

The uplink and flexible symbol of the NCR-Fwd in TimeDomainAssignment #1 (for example, the uplink and flexible symbols determined according to semi-static configuration information) apply/use corresponding beam indication (or the spatial filter corresponding to respective beam indexes) for uplink reception.

Optionally, the DCI format includes a switch field. Optionally, the size of the switch field of the DCI format is determined according to the maximum number of the time domain resource indications (M) corresponding to one or more time domain information in the time domain information set. For one time domain resource in-dication, it is either for ON or for OFF. Therefore, the switch indication bit corresponding to one time domain resource indications is 1 bit. Further, according to the above time domain resource configuration information, there may be at most M time domain resource indications, so the size of the switch field is M. In combination with the above example, it is further explained that for the configured 5 entries, the maximum number of time domain resource indications M is 4. Therefore, the total size of the switch field is 4 bits. Each bit corresponds to one time domain resource indication. Specifically, when entry #2 is indicated, the first bit of the switch field corresponds to TimeDomainAssignment #1; the second bit of the switch field corresponds to TimeDomainAssignment #2, and so on.

Optionally, the DCI format includes a second field; wherein the second field is used for indicating uplink or downlink or OFF. For one time domain resource indication, it is for one of uplink, downlink or OFF. Therefore, the indication bits of the second field corresponding to one time domain resource indicator are 2 bits. Further, according to the above time domain resource configuration information, there may be at most M time domain resource indications, so the size of the second field is 2*M. For behaviors of the NCR-Fwd when one time domain resource is indicated as uplink, downlink or OFF, refer to the description of the uplink and downlink field and/or the switch field.

In this embodiment, the NCR-MT monitors the DCI format, which may be un-derstood as the NCR-MT monitoring DCI format in a search space. Optionally, the search space refers to at least one of the followings: a Type3-PDCCH CSS; a USS set.

A payload size of the DCI format described in this embodiment is determined by one of the following methods:

### Method 1

Indicated by the base station (or indicated explicitly by the base station). For example, the payload size of the DCI format is configured by RRC parameter. For example, the maximum value configured by this parameter is 126 bits.

### Method 2

Determined according to the payload size of other DCI formats.

Optionally, other DCI formats refer to one of the followings: DCI format 1_0, DCI format 1_1, DCI format 1_2, DCI format 0_0, DCI format 0_1 and DCI format 0_2.

Optionally, the other DCI formats mentioned above refer to DCI formats monitored in a common search space.

Optionally, the other DCI formats mentioned above refer to DCI formats monitored in a UE-specific search space.

Optionally, the other DCI formats mentioned above refer to DCI format 1_0 monitored in the common search space.

For example, the number of information bits in the DCI format should be equal to or less than the payload size of DCI format 1_0 monitored in the common search space in a cell (e.g., the same serving cell or PCell). If the number of information bits in the DCI format is smaller than the payload size of the DCI format 1_0 monitored in the common search space in a cell (e.g., the same serving cell or a PCell), zero should be appended to the DCI format until the payload size is equal to the payload size of the DCI format 1_0 monitored in the common search space in a cell (e.g., the same serving cell or a PCell).

Advantageous Effects of Embodiment 1A: In this embodiment, a method for NCR to determine the corresponding characteristics of DCI format for controlling NCR-Fwd is described. Therefore, the NCR can correctly monitor the corresponding DCI format, so as to correctly receive the DCI format and perform subsequent operations. This improves the reliability of the communication system. In addition, in this embodiment, the NCR can determine the size of the corresponding domain in the DCI format by acquiring the characteristics of the time domain information set, which clarifies behaviors of the NCR and improves the reliability of the system.

For the following embodiments 1B-1D, it can be understood that the specific beam ID is not used to indicate the beam for the NCR-Fwd, but is used to indicate whether the NCR-Fwd is ON or OFF (in the on state or in the off state). In addition, the beam ID other than the specific beam ID is used for beam indication of the NCR-Fwd. Because the time of applying beam indication and switch indication is different, method is needed to distinguish the application time. Therefore, the following scheme is proposed to enable NCR to determine the corresponding application time of the corresponding indication signaling, thus avoiding the ambiguity of the indicated application time, and improving the performance of the system.

### Embodiment 1B

The NCR-MT receives an indication; the indication corresponds to a beam ID. The beam ID may refer to the above-mentioned specific beam ID (used to indicate the ON or OFF of the NCR-Fwd) or the beam ID (of the beam/spatial filter) used to indicate the NCR-Fwd to receive and/or forward.

Optionally, the indication corresponds to one DCI.

Optionally, the beam ID corresponds to one time domain resource.

Optionally, the NCR-Fwd applies the beam indication on the time domain resource. In other words, the NCR-Fwd uses the beam ID (related spatial filter) for uplink reception and/or downlink forwarding on the corresponding time domain resources according to the indication.

Optionally, the NCR-Fwd does not forward in the time domain resource.

Optionally, the NCR determines the time to apply the indication (or the time required to apply the indication) according to the beam ID. For example, when the beam ID is not equal to a specific value, the time for applying the indication is a first time (e.g., beam application time). For another example, when the beam ID is equal to a specific value, the time for applying the indication is a second time (for example, the time for applying the switch. Another example is the switching time. Another example is the ON time. Another example is the OFF time). Optionally, the specific value may be one or more. Optionally, the specific value is, for example, at least one of −1, −2, 0, 1 and 2. Optionally, the specific value is the lowest beam ID (configured by the base station).

Optionally, the NCR applies the corresponding indication (for example, applies the corresponding beam indication) after the first time of receiving the indication (or transmitting the feedback corresponding to the indication).

Optionally, the NCR applies the corresponding indication (for example, applies the corresponding switch indication) after the second time of receiving the indication (or transmitting the feedback corresponding to the indication).

### Embodiment 1C

The NCR receives an indication; the indication corresponds to one or more beam IDs. The one or more beam IDs may refer to the above-mentioned specific beam ID (beam ID for indicating the ON or OFF of the NCR-Fwd) or beam ID (of a beam/spatial filter) for instructing the NCR-Fwd to receive and/or forward.

Optionally, the indication corresponds to one DCI.

Optionally, each of the one or more beam IDs corresponds to one time domain resource.

Optionally, the NCR-Fwd applies the corresponding beam ID (beam ID for beam indication of the NCR-Fwd) on the corresponding time domain resource. In other words, the NCR-Fwd uses the one or more beam IDs (related spatial filters) for uplink reception and/or downlink forwarding on the corresponding time domain resource according to the indication.

Optionally, the NCR-Fwd does not forward on the corresponding time domain resources.

Optionally, the NCR determines the time to apply the indication (or the time required to apply the indication) according to the one or more beam IDs. For example, when at least one of the one or more beam IDs is equal to a specific value and the other is not, the time for applying the indication is one of the following.
A first time (e.g., beam application time);
A second time (e.g., the time to apply the switch. Another example is the switching time. Another example is the ON time. Another example is the OFF time);
The longer time of the first time and the second time;
The shorter time of the first time and the second time.

For another example, when one or more beam IDs are not equal to a specific value, the time for applying the indication is the first time (e.g., beam application time). For another example, when the beam ID is equal to a specific value, the time for applying the indication is a second time (for example, the time for applying the switch. Another example is the switching time. Another example is the ON time. Another example is the OFF time).

Optionally, the specific value may be one or more. Optionally, the specific value is, for example, at least one of −1, −2, 0, 1 and 2. Optionally, the specific value is the lowest beam ID (configured by the base station).

Optionally, the NCR applies the corresponding indication (for example, applies the corresponding beam indication) after the first time of receiving the indication (or transmitting the feedback corresponding to the indication).

Optionally, the NCR applies the corresponding indication (for example, applies the corresponding switch indication) after the second time of receiving the indication (or transmitting the feedback corresponding to the indication).

### Embodiment 1D

The NCR receives an indication; the indication corresponds to one or more beam IDs. The one or more beam IDs may refer to the above-mentioned specific beam ID (beam ID for indicating the ON or OFF of the NCR-Fwd) or beam ID (of a beam/spatial filter) for instructing the NCR-Fwd to receive and/or forward.

Optionally, the indication corresponds to one DCI.

Optionally, each of the one or more beam IDs corresponds to one time domain resource.

Optionally, the NCR-Fwd applies the corresponding beam ID (beam ID for beam indication of the NCR-Fwd) to the corresponding time domain resources.

Optionally, the NCR-Fwd does not forward on the corresponding time domain resources.

Optionally, the NCR expects that one or more beam IDs all correspond to one specific value; optionally, the NCR expects that the one or more beam IDs do not correspond to one specific value.

Optionally, the NCR determines the time to apply the indication (or the time required to apply the indication) according to the one or more beam IDs. For example, when one or more beam IDs are not equal to one specific value, the time for applying the indication is the first time (e.g., beam application time). For another example, when the beam ID is equal to a specific value, the time for applying the indication is a second time (for example, the time for applying the switch. Another example is the switching time. Another example is the ON time. Another example is the OFF time).

Optionally, the specific value may be one or more. Optionally, the specific value is, for example, at least one of −1, −2, 0, 1 and 2. Optionally, the specific value is the lowest beam ID (configured by the base station).

Optionally, the NCR applies the corresponding indication (for example, applies the corresponding beam indication) after a first time after receiving the indication signaling (or transmitting the feedback corresponding to the indication).

Optionally, the NCR applies the corresponding indication (for example, applies the corresponding switch indication) after a second time after receiving the indication signaling (or transmitting the feedback corresponding to the indication).

### Embodiment 2 (NCR-Fwd Beam Information Mapping)

FIG. 7 illustrates another method 700 performed by the NCR according to various embodiments of the disclosure. The method 700 includes: in step 701, receiving a plurality of beam information; in step 702, determining a mapping relationship and/or a grouping relationship between the plurality of beam information.

Specifically, the NCR receives/determines the plurality of beam information from the base station. Here, the NCR may be understood as the NCR-MT. For example, the NCR-MT receives indication information (configuration information) from a base station, which indicates/configures N beam information, where N may be a positive integer greater than 1, such as 4, 6, 8, 12, 16, etc. The definition of beam information here refers to the explanation of the first beam information in Embodiment 1 (for example, beam ID, reference signal ID, TCI ID, panel ID, BWP and/or CC information, etc.). For another example, the NCR-MT determines N beam information (e.g., beam IDs). Wherein N is predefined or reported by the NCR (or reported by the NCR capability signaling).

After receiving the above-mentioned plurality of beam information, the NCR may have three different follow-up operations for the plurality of beam information, the goal of which is to make the base station and the NCR have the same understanding of the mapping relationship or grouping relationship between the plurality of beams. It may be understood that in the case of “predefined” in Example 1 described below, the base station knows the mapping relationship or grouping relationship between the plurality of beams it sends to the NCR from the beginning based on the predefined rules in the standard specification (NCR follows the same predefined rules to determine the mapping relationship or grouping relationship between the plurality of beams it receives). Specific operations are explained by the following three examples.

### EXAMPLE 1 (PREDEFINED)

In Example 1, the NCR determines the mapping relationship or grouping relationship between received plurality of beam information according to predefined rules.

Here, for determining the mapping relationship (for example, QCL relationship/information), at least one of the following methods can be adopted:

### Method 1 (Beam ID)

For the first method, the beam information is the beam ID. Optionally, there is a one-to-many mapping between beam IDs. Specifically, the NCR receives (or determines) N beam IDs (for example, N is configured by the base station). The predefined rules here mean that M of N beam IDs are mapped with another N−M beam IDs. Wherein M or N−M is indicated by the base station or reported by the NCR capability (or a fixed value, for example, M=1). Optionally, there is a one-to-many mapping between the M beam information and the N−M beam information. That is, one of the M beam information is mapped (or there is a mapping relationship) with a plurality of the N−M beam information. Optionally, one (or each) of the plurality of beam information (a plurality of beam information among N−M beam information) and the corresponding beam information (one of M beam information) are QCLed. In this scheme, the correlation between one of M beam information and a plurality of N−M beam information may be understood as the correlation between one wide beam (information) and a plurality of narrow beams (information). The relationship between the wide beam and the narrow beam is, for example, that a boresight direction of the narrow beam is within the 3 dB beam width of the wide beam. For another example, the relationship between the wide beam and the narrow beam is that the 3 dB beam width of the narrow beam is smaller than the 3 dB beam width of the wide beam.

For example, in this example, N beams are arranged in ascending order of beam IDs (for example, beam #0 is the first beam information in N; Beam #N−1 is the last beam information in N), and M beam information is the first M of N beam information; the N−M beam information is the last N−M beam information of the N beam information. The first beam information among the M beam information is mapped (associated) with the previous └(N−M)/M┘ beam information among the N−M beam information. The second beam in the M beam information is mapped (associated) with the beam information after the previous └(N−M)/M┘ beam information in the N−M beam in-formation, and so on. For example, N=9 and M=2. └(N−M)/M┘=3. That is, the first beam information (beam #0) among M beam information corresponds to the first three beam information of N−M; the second beam information among M beam information corresponds to the last four (4th to 7th) beam information among N−M beam information. For example, N=5 and M=1. =4. └(N−M)/M┘=4. That is, the first beam information in N beams corresponds to the last 4 beams in N beam information.

For another example, N beams are arranged in ascending order of beam IDs, and M beam information in N and N−M beam information in N are interleaved. Specifically, the first of N beam information is the first of M beam information, and the second to the first └(N−M)/M┘+1 of N beam information are the first └(N−M)/M┘ of N−M′ and they are corresponding (associated). The first └(N−M)/M┘+2 of N beam information is the second of M beam information, and the └(N−M)/M┘+3 to the 2*└(N−M)/M┘+2 of N beam information are the first └(N−M)/M┘ of N−M′ and they are corresponding (associated). And so on. For example, N=6 and M=2. Beam #0 corresponds to {beam #1, beam #2}; beam #3 corresponds to {beam #4, beam #5}.

### Method 2 (Reference Signal ID, #1)

For the second method, the beam information is the reference signal ID. The NCR receives (or determines) a plurality of reference signal IDs from the base station. The predefined rule here means that NCR determines the mapping relationship between beam information (reference signal ID) according to the type of reference signal. Wherein, the total number of reference signals corresponding to the plurality of beam information (reference signal ID) is N, including M SSBs and N−M CSI-RSs. Here, M SSBs may be determined by at least one of the following ways:
SSB determined by the NCR-MT according to initial access procedure;
SSB determined by the NCR-MT according to the MAC-CE signaling of the base station. The MAC-CE signaling indicates/activates the TCI state corresponding to CORESET #0, and the TCI state and the SSB are QCLed;
SSB determined by the NCR-MT according to the dedicated signaling of the base station. Optionally, the dedicated signaling indicates which SSBs NCR forwards, or which SSBs to use for beam sweeping.

In Method 2, optionally, there is a one-to-many mapping between the M beam information and the N−M beam information. That is, one of the M beam information is mapped (or there is a mapping relationship) with a plurality of the N−M beam information. Optionally, one (or each) of the plurality of beam information (a plurality of beam information among N−M beam information) and the corresponding beam information (one of M beam information) are QCL. In this scheme, the correlation between one of M beam information and a plurality of N−M beam information may be understood as the correlation between a wide beam (information) and a plurality of narrow beams (information). The relationship between the wide beam and the narrow beam is, for example, that the boresight direction of the narrow beam is within the 3 dB beam width of the wide beam. For another example, the relationship between the wide beam and the narrow beam is that the 3 dB beam width of the narrow beam is smaller than the 3 dB beam width of the wide beam.

Here, the M beam information is sorted according to the ascending order of the reference signal ID (or the reference signal resource ID); N−M beam information is sorted according to the ascending order of reference signal ID (or reference signal resource ID). Specifically, the mapping mode between M beam information and N−M beam information is illustrated in Method 1.

In addition, in Method 2, M SSBs may be equivalently replaced by M CSI-RSs, and NCR determines M CSI-RSs according to the indication of the base station. The specific mapping method between M beam information and N−M beam information is the same as the case of M SSBs.

### Method 3 (Reference Signal ID, #2)

For Method 3, the beam information is the reference signal ID. The NCR receives (or determines) a plurality of reference signal IDs from the base station. The predefined rule here means that NCR determines the mapping relationship between beam information (reference signal ID) according to the type of reference signal. Wherein, the plurality of beam information (reference signal ID) corresponds to one SSB and a plurality of CSI-RSs. Optionally, this SSB may be determined by at least one of the following ways:
SSB determined by the NCR-MT according to the initial access procedure;
SSB determined by the NCR-MT according to the MAC-CE signaling of the base station. The MAC-CE signaling indicates/activates the TCI state corresponding to CORESET #0, and the TCI state and the SSB are QCLed;
The SSB determined by the NCR-MT according to the dedicated signaling of the base station. Optionally, the dedicated signaling indicates which SSBs NCR forwards, or which SSBs to use for beam sweeping.

Wherein, one (or each) of the plurality of CSI-RSs is associated with the SSB. Optionally, the association between CSI-RS and SSB means that CSI-RS and SSB are QCL. Optionally, the association of CSI-RS with one SSB means that the qcl-InfoperiodicCSI-RS parameter of CSI-RS is the SSB (or the TCI state corresponding to the qel-InfoperiodicCSI-RS parameter includes the SSB).

In Method 3, optionally, there is a one-to-many mapping between one SSB and a plurality of CSI-RSs. Optionally, (one/each) of the above SSB and CSI-RS is QCL.

In addition, in Method 3, one SSB may be equivalently replaced by one CSI-RS, and NCR determines this CSI-RS according to the indication of the base station.

### Method 4 (Beam ID+Reference Signal ID)

For method 4, the beam information is the beam ID and the reference signal ID (the beam ID is associated with the reference signal). This method is similar to Method 2, in which M SSBs (for example, SSB ID in ascending order) are mapped to M beam IDs (for example, ID in ascending order) one by one; N−M CSI-RSs (ascending CSI-RS resource ID) are mapped to N−M beam IDs (for example, ascending ID) one by one. See Method 1 for the mapping relationship between M beam IDs and N−M beam IDs.

Here, the following methods may be used to determine the grouping relationship:

The NCR receives a plurality of beam information from the base station, and the NCR groups the received plurality of beam information according to predefined rules. For example, the number of the plurality of beam information is N, wherein M beam information belongs to one group (group #0) and N−M beam information belongs to another group (group #1). M is N/2 (or rounding up/down of N/2). Optionally, the N beam information is sorted in ascending order/descending order according to the ID corresponding to the beam information. Optionally, the M beam information refers to the first M of the N beam information. It may be understood that grouping the plurality of beam information here may include dividing the plurality of beam information into more than two groups.

The NCR can simultaneously apply beam information from different beam information groups. It may be understood that the NCR-Fwd can simultaneously use the spatial filter corresponding to one beam information in group #0 and the spatial filter corresponding to one beam information in group #1 for downlink forwarding and/or uplink reception.

Within one time domain resource (or one time instance), only one beam information in a beam information group (for example, in each beam information group mentioned above) can be used for downlink forwarding and/or uplink reception.

In Method 4, the beam information refers to the beam ID and/or the reference signal information (reference signal ID).

### EXAMPLE 2 (BASE STATION INDICATION)

In Example 2, the NCR determines the mapping relationship or grouping relationship between the received plurality of beam information according to the indication of the base station.

Here, for determining the mapping relationship (for example, QCL relationship), the following methods may be adopted:

### Method 1

The base station indicates the mapping relationship between the plurality of beam information. Optionally, the mapping relationship between the plurality of beam information is a one-to-many mapping relationship (for example, QCL relationship). In other words, one beam information (corresponding beam) and each beam information (corresponding beam) of the plurality of beam information are QCLed. For example, the base station indicates that beam information #0 is associated with {beam information #1, beam information #2, beam information #3 and beam information #4}, that is, beam information #0 has a QCL relationship (is QCLed) with one (or each) of {beam information #1, beam information #2, beam information #3 and beam information #4}. In this scheme, the correlation between one beam information and the plurality of beam information may be understood as the correlation between a wide beam (information) and a plurality of narrow beams (information). The relationship between the wide beam and the narrow beam is, for example, that the boresight direction of the narrow beam is within the 3 dB beam width of the wide beam. For another example, the relationship between the wide beam and the narrow beam is that the 3 dB beam width of the narrow beam is smaller than the 3 dB beam width of the wide beam.

### Method 2

The base station indicates the mapping relationship between the plurality of beam information. Specifically, the number of beam information is N. Wherein, M (first group) of N beam information are mapped with other N−M beam information (second group). The mapping relationship is provided by the base station. Optionally, the mapping relationship between M beam information and N−M beam information is a one-to-many mapping relationship (for example, a QCL relationship). In other words, one beam information (corresponding beam) and each beam information (corresponding beam) of the plurality of beam information are QCLed. Wherein M is indicated by the base station or reported by the NCR capability. For example, N=6, M=2, beam information #0 and beam information #1 are the first group, beam information #2, beam information #3, beam information #4 and beam information #5 are the second group. The base station indicates that beam information #0 is associated with {beam information #2 and beam information #4}, that is, beam information #0 has a QCL relationship (is QCLed) with one or each of {beam information #2 and beam information #4}. The base station indicates that beam information #1 is associated with {beam information #3 and beam information #5}, that is, beam information #1 has a QCL relationship (is QCLed) with one or each of {beam information #3 and beam information #5}. In this scheme, the correlation between one beam information and the plurality of beam information may be understood as the correlation between a wide beam (information) and a plurality of narrow beams (information). The relationship between the wide beam and the narrow beam is, for example, that the boresight direction of the narrow beam is within the 3 dB beam width of the wide beam. For another example, the relationship between the wide beam and the narrow beam is that the 3 dB beam width of the narrow beam is smaller than the 3 dB beam width of the wide beam.

Here, the following methods may be used to determine the grouping relationship:

The base station indicates that a part of the plurality of beam information is one group (for example, corresponding group ID #0); the base station indicates that a part (or other part) of the plurality of beam information is another group (for example, corresponding group ID #1). Optionally, the elements in group ID #0 and group ID #1 are mutually exclusive.

NCR can simultaneously apply beam information from different beam information groups. It may be understood that NCR-Fwd can simultaneously use the spatial filter corresponding to one beam information in group ID #0 and the spatial filter corresponding to one beam information in group #1 for downlink forwarding and/or uplink reception.

Optionally, within one time domain resource (or one time instance), only one beam information in one beam information group (for example, in each beam information group mentioned above) can be used for downlink forwarding and/or uplink reception.

### EXAMPLE 3 (NCR REPORTING)

In this example, the NCR reports a mapping relationship or a grouping relationship between the plurality of beam information. In other words, the NCR informs the base station of the mapping relationship between its preferred/recommended beam information.

Here, for the reporting of mapping relationships (for example, QCL relationships), the following methods may be adopted:

### Method 1

NCR reports the mapping relationship between the plurality of beam information. Optionally, the mapping relationship between the plurality of beam information is a one-to-many mapping relationship (for example, QCL relationship). In other words, one beam information (corresponding beam) and each beam information (corresponding beam) of the plurality of beam information are QCLed. For example, the NCR reports that beam information #0 is associated with {beam information #1, beam information #2, beam information #3 and beam information #4}, that is, beam information #0 has a QCL relationship (is QCLed) with each of {beam information #1, beam information #2, beam information #3 and beam information #4}. In this scheme, the correlation between one beam information and the plurality of beam information may be understood as the correlation between one wide beam (information) and a plurality of narrow beams (information). The relationship between the wide beam and the narrow beam is, for example, that the boresight direction of the narrow beam is within the 3 dB beam width of the wide beam. For another example, the relationship between the wide beam and the narrow beam is that the 3 dB beam width of the narrow beam is smaller than the 3 dB beam width of the wide beam.

### Method 2

NCR reports the mapping relationship between the plurality of beam information. Specifically, the number of beam information is N. Wherein M (first group) of N beam information are mapped with other N−M beam information (second group). The mapping relationship was reported by the NCR. Optionally, the mapping relationship between M beam information and N−M beam information is a one-to-many mapping relationship (for example, a QCL relationship). In other words, one beam information (corresponding beam) and each beam information (corresponding beam) of the plurality of beam information are QCLed. Wherein M is indicated by the base station or reported by the NCR capability. For example, N=6, M=2, beam information #0 and beam information #1 are the first group, beam information #2, beam information #3, beam information #4 and beam information #5 are the second group. The NCR reports that the beam information #0 is associated with {beam information #2 and beam information #4}, that is, beam information #0 has a QCL relationship (is QCLed) with each of {beam information #2 and beam information #4}. The NCR reports that the beam information #1 is associated with {beam information #3 and beam information #5}, that is, beam information #1 has a QCL relationship (is QCLed) with each of {beam information #3 and beam information #5}. In this scheme, the correlation between one beam information and the plurality of beam information may be understood as the correlation between a wide beam (information) and a plurality of narrow beams (information). The relationship between the wide beam and the narrow beam is, for example, that the boresight direction of the narrow beam is within the 3 dB beam width of the wide beam. For another example, the relationship between the wide beam and the narrow beam is that the 3 dB beam width of the narrow beam is smaller than the 3 dB beam width of the wide beam.

Here, the following methods may be used to determine the grouping relationship:

NCR reports that a part of the plurality of beam information is one group (for example, corresponding group ID #0); NCR reports that a part of the plurality of beam information is another group (for example, corresponding group ID #1). Optionally, the clements in group ID #0 and group ID #1 are mutually exclusive.

NCR can simultaneously apply beam information from different beam information groups. It may be understood that NCR-Fwd can simultaneously use the spatial filter corresponding to one beam information in group ID #0 and the spatial filter corresponding to one beam information in group #1 for downlink forwarding and/or uplink reception.

Optionally, within one time domain resource (or a time instance), only one beam information in one beam information group (for example, in each beam information group mentioned above) can be used for downlink forwarding and/or uplink reception.

Optionally, after the NCR reports the mapping relationship or grouping relationship between the plurality of beam information, the NCR receives corresponding feedback from the base station. It may be understood that after the NCR reports the mapping relationship or grouping relationship between beam information, the base station will generate a feedback for this report and transmit this feedback to the NCR; correspondingly, the NCR receives this feedback. Here, feedback may be understood as ACK information, or, the mapping relationship between reported beam information or the ACK information corresponding to the grouping relationship.

Optionally, after the NCR receives the feedback, the NCR applies the mapping relationship or grouping relationship it reported to the base station. It may be understood here that after the NCR receives this feedback information from the base station for a period of time, it applies the mapping relationship or grouping relationship of the previously reported beam information. Optionally, the above period of time refers to X time slots, Y symbols or Z milliseconds. Optionally, X, Y and Z are fixed values (for example, X=1 or 2, Y=28 and Z=3). Optionally, the values of X, Y and Z are reported (by the NCR via capability signaling). Optionally, after the NCR receives the feedback, and the feedback is NACK, the NCR does not apply the mapping relationship or grouping relationship it reports to the base station.

For the method described in Example 3, the mapping relationship or grouping relationship between the plurality of beam information is reported by at least one of the following methods:

### Method 1

Reported by CSI. That is, the mapping relationship or grouping relationship between the plurality of beam information is sent to the base station through CSI report, wherein the CSI report is carried by PUCCH or PUSCH.

### Method 2

MAC-CE. That is, the mapping relationship or grouping relationship between the plurality of beam information is sent to the base station through MAC-CE signaling.

### Method 3

PUCCH/PUSCH. That is, the mapping relationship or grouping relationship between the plurality of beam information is sent to the base station through PUCCH/PUSCH.

### Method 4

Msg3/MsgA. Specifically, the mapping relationship or grouping relationship between the plurality of beam information is sent to the base station through Msg3/MsgA based on contention/contention-free random access procedure.

For the method described in Example 3, the above feedback is indicated to the NCR in one of the following methods:

### Method 1

The feedback is indicated by a PDCCH. Here, it may be understood that the feedback is indicated by DCI, or the feedback is a PDCCH, and wherein the PDCCH satisfies one of the followings:

The DCI corresponding to the PDCCH is monitored by a specific search space. Optionally, the (CRC) of the PDCCH corresponding to the DCI is scrambled by C-RNTI;

The PUSCH scheduled by DCI corresponding to the PDCCH is the same as the HARQ process ID of the PUSCH carrying the mapping relationship or grouping relationship. Optionally, the value of NDI domain corresponding to the DCI is toggled NDI domain value.

### Method 2

The feedback is indicated by MAC-CE signaling.

### Method 3

This feedback is indicated by TCI state activation and/or update signaling. For example, the base station indicates and/or activates a TCI state code point, which is used to convey the feedback (information).

Advantageous effects of Embodiment 2: Embodiment 2 provides a beam mapping method of the NCR-Fwd. This method can provide the characteristics corresponding to the beam information of the NCR-Fwd (for example, the width of the beam and the panel where the beam is located), so that the base station can control the receiving beam/transmitting beam for the NCR-Fwd corresponding to the access link, thereby improving the quality of the access link and the performance of the communication system.

FIG. 8 illustrates a method 800 performed by a base station according to various embodiments of the disclosure. The method 800 includes: in step 801, determining first beam information, wherein the first beam information is used for instructing a repeater to perform downlink forwarding and/or uplink reception; in step 802, transmitting the first beam information to the repeater.

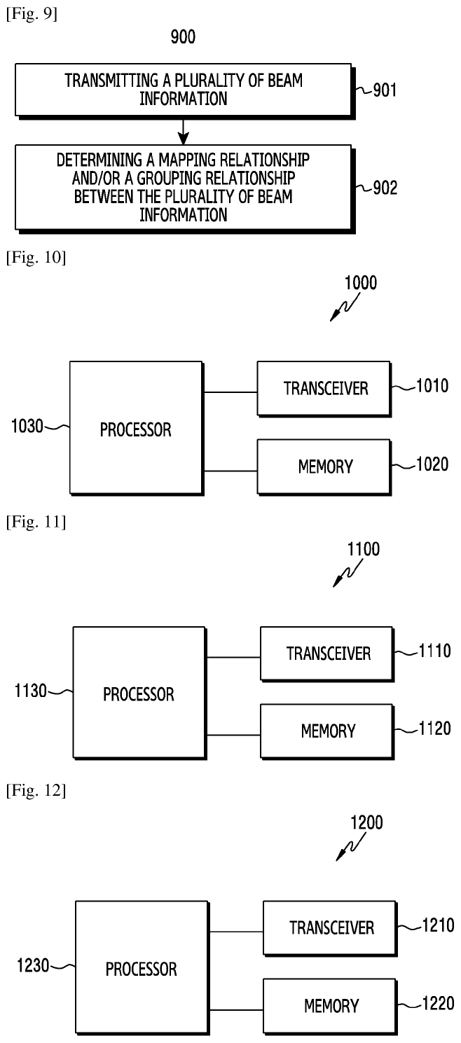

FIG. 9 illustrates another method 900 performed by a base station according to various embodiments of the disclosure. The method 900 includes: in step 901, transmitting a plurality of beam information to the repeater; in step 902, determining a mapping relationship and/or a grouping relationship between the plurality of beam information.

The mobile terminal NCR-MT and NCR-Fwd of the repeater shown in FIG. 5 are respectively configured to perform the corresponding methods disclosed herein.

FIG. 10 shows a structure 1000 of a UE according to various embodiments of the disclosure.

As shown in FIG. 10, the UE according to an embodiment may include a transceiver 1010, a memory 1020, and a processor 1030. The transceiver 1010, the memory 1020, and the processor 1030 of the UE may operate according to a communication method of the UE described above. However, the components of the UE are not limited thereto. For example, the UE may include more or fewer components than those described above. In addition, the processor 1030, the transceiver 1010, and the memory 1020 may be implemented as a single chip. Also, the processor 1030 may include at least one processor. Furthermore, the UE of FIG. 10 corresponds to the UE 116 of the FIG. 3A.

The transceiver 1010 collectively refers to a UE receiver and a UE transmitter, and may transmit/receive a signal to/from a base station or a network entity. The signal transmitted or received to or from the base station or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the UE. Also, the memory 1020 may store control information or data included in a signal obtained by the UE. The memory 1020 may be a storage medium, such as read-only memory (ROM), random access memory (RAM), a hard disk, a CD-ROM, and a DVD, or a combination of storage media.

The processor 1030 may control a series of processes such that the UE operates as described above. For example, the processor 1030 is configured to perform the methods described in FIG. 8 and FIG. 9 above. the transceiver 1010 may receive a data signal including a control signal transmitted by the base station or the network entity, and the processor 1030 may determine a result of receiving the control signal and the data signal transmitted by the base station or the network entity.

FIG. 11 illustrates a structure 1100 of a repeater according to various embodiments of the disclosure.

As shown in FIG. 11, the repeater according to an embodiment may include a transceiver 1110, a memory 1120, and a processor 1130. The transceiver 1110, the memory 1120, and the processor 1130 of the repeater may operate according to a communication method of the repeater described above. However, the components of the repeater are not limited thereto. For example, the repeater may include more or fewer components than those described above. In addition, the processor 1130, the transceiver 1110, and the memory 1120 may be implemented as a single chip. Also, the processor 1130 may include at least one processor. Furthermore, the repeater of FIG. 11 corresponds to the NCR of the FIG. 5.

The transceiver 1110 collectively refers to a repeater receiver and a repeater transmitter, and may transmit/receive a signal to/from a base station or a network entity. And the transceiver may transmit/receive a signal to/from a UE. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the repeater. Also, the memory 1120 may store control information or data included in a signal obtained by the repeater. The memory 1120 may be a storage medium, such as read-only memory (ROM), random access memory (RAM), a hard disk, a CD-ROM, and a DVD, or a combination of storage media.

The processor 1130 may control a series of processes such that the repeater operates as described above. For example, the transceiver 1110 may receive a data signal including a control signal transmitted by the base station or the network entity, and the processor 1130 may determine a result of receiving the control signal and the data signal transmitted by the base station or the network entity. Also, the transceiver 1110 may transmit a data signal including a control signal to the UE transmitted by the base station or the network entity.

FIG. 12 illustrates a structure 1200 of a base station according to various embodiments of the disclosure.

As shown in FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor. Furthermore, the base station of FIG. 12 corresponds to the gNB 102 of the FIG. 3B.

The transceiver 1210 collectively refers to a base station receiver and a base station transmitter, and may transmit/receive a signal to/from a terminal (UE) or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

In this disclosure, the terms “cell” and “carrier” (for example, component carrier CC) may be used interchangeably. The expression “NCR-Fwd applies beam ID (related/corresponding spatial filter) for downlink forwarding and/or uplink reception” in various embodiments described herein may mean, for example, that NCR-Fwd applies spatial filter related/corresponding to beam ID for downlink forwarding and/or uplink reception, and “NCR-Fwd applies reference signal ID (related/corresponding spatial filter) for downlink forwarding and/or uplink reception” may mean, for example, that NCR-Fwd applies spatial filter related/corresponding to reference signal ID for downlink forwarding and/or uplink reception.

In this disclosure, it may be understood that the described channel or signal is indicated by the base station to the repeater (NCR).

In addition, “at least one entry/at least one” described in this disclosure includes any and/or all possible combinations of listed entries, and various embodiments and examples in embodiments described in this disclosure may be changed and combined in any suitable form, and “/” described in this disclosure means “and/or”.

In addition, the beam ID may be understood as a logical beam ID. For example, the repeater described in this disclosure may also be understood as a Reconfigurable Intelligent Surface (RIS), and the corresponding method may also be applied to the intelligent hypersurface.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The illustrative logical blocks, modules, and circuits described in this disclosure may be implemented in a general-purpose processor, a Digital Signal Processor (DSP), an Application Specific Integrated Circuit (ASIC), Field Programmable Gate Array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, micro-controller, or state machine. A processor may also be implemented as a combination of computing devices, such as a combination of a DSP and a microprocessor, a plurality of microprocessors, one or more microprocessors cooperating with a DSP core, or any other such configuration.

The steps of a method or algorithm described in this disclosure may be embodied directly in hardware, in a software module executed by a processor, or in a combination of the two. Software modules may reside in RAM memory, flash memory, ROM memory, EPROM memory, EEPROM memory, registers, hard disks, removable disks, or any other form of storage media known in the art. An exemplary storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more exemplary designs, the described functions may be implemented in hardware, software, firmware, or any combination thereof. If implemented in software, each function may be stored on or transmitted by a computer-readable medium as one or more indications or codes. Computer-readable media include both computer storage medium and communication medium, and the latter includes any medium that facilitates the transfer of computer programs from one place to another. The storage medium may be any available medium that can be accessed by a general-purpose or special-purpose computer.

The description set forth herein, taken in conjunction with the drawings, describes example configurations, methods and devices, and does not represent all examples that can be realized or are within the scope of the claims. As used herein, the term “example” means “serving as an example, instance or illustration” rather than “preferred” or “superior to other examples”. The detailed description includes specific details in order to provide an understanding of the described technology. However, these techniques may be practiced without these specific details. In some cases, well-known structures and devices are shown in block diagrams to avoid obscuring the concepts of the described examples.

Although this specification contains many specific implementation details, these should not be interpreted as limitations on any invention or the scope of the claimed protection, but as descriptions of specific features of specific embodiments of specific inventions. Some features described in this specification in the context of separate embodiments may also be combined in a single embodiment. On the contrary, various features described in the context of a single embodiment may also be implemented separately in a plurality of embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

It should be understood that the specific order or hierarchy of steps in the method of the present invention is illustrative of an exemplary process. Based on the design preference, it may be understood that the specific order or hierarchy of steps in the method may be rearranged to realize the functions and effects disclosed in the present invention. The appended method claims present elements of various steps in an example order, and are not meant to be limited to the particular order or hierarchy presented, unless otherwise specifically stated. Furthermore, although elements may be described or claimed in the singular, the plural is also contemplated unless the limitation to the singular is explicitly stated. Therefore, the disclosure is not limited to the illustrated examples, and any means for performing the functions described herein are included in various aspects of the disclosure.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

1-15. (canceled)

16. A method performed by a network-controlled repeater (NCR) including an NCR mobile termination (NCR-MT) and an NCR forwarding (NCR-Fwd) in a wireless communication system, the method comprising:
receiving, from a base station, side control information including information on a beam index and information on a time resource for communication on an NCR-Fwd access link; and
communicating with a user equipment (UE) using a beam in a slot, based on the beam index and the time resource, wherein the slot is associated with a beam with a same index,
wherein data is forwarded between the base station and the UE via an NCR-Fwd backhaul link and the NCR-Fwd access link.

17. The method of claim 16,
wherein the time resource and the beam index corresponding to the time resource are indicated by downlink control information (DCI).

18. The method of claim 16,
wherein the information on the time resource includes at least one of a slot offset from a reference slot to the slot, a symbol offset from a first symbol in the slot, a reference subcarrier spacing (SCS), or a length of symbols in the slot, and
wherein a first SCS of a first slot which received downlink control information (DCI) is equal to a second SCS provided by the reference SCS.

19. The method of claim 18,
wherein the reference slot is a second slot with the second SCS, and
wherein the reference slot is identified based on capability information of the NCR.

20. The method of claim 16,
wherein, in case that a plurality of beam indexes for time resources are identified, the beam index corresponds to a most recent physical downlink control channel (PDCCH) monitoring occasion detected by the NCR.

21. A method performed by a base station in a wireless communication system, the method comprising:
transmitting, to a network-controlled repeater (NCR) including an NCR mobile termination (NCR-MT) and an NCR forwarding (NCR-Fwd), side control information including information on a beam index and information on a time resource for communication on an NCR-Fwd access link; and
communicating, with a user equipment (UE) using a beam in a slot, based on the beam index and the time resource, wherein the slot is associated with a beam with a same index,
wherein data is forwarded between the base station and the UE via an NCR-Fwd backhaul link and the NCR-Fwd access link.

22. The method of claim 21,
wherein the time resource and the beam index corresponding to the time resource are indicated by downlink control information (DCI).

23. The method of claim 21,
wherein the information on the time resource includes at least one of a slot offset from a reference slot to the slot, a symbol offset from a first symbol in the slot, a reference subcarrier spacing (SCS), or a length of symbols in the slot.

24. The method of claim 23,
wherein a first SCS of a first slot which received downlink control information (DCI) is equal to a second SCS provided by the reference SCS,
wherein the reference slot is a second slot with the second, and
wherein the reference slot is identified based on capability information of the NCR.

25. The method of claim 21,
wherein, in case that a plurality of beam indexes for time resources are identified, the beam index corresponds to a most recent physical downlink control channel (PDCCH) monitoring occasion detected by the NCR.

26. A network-controlled repeater (NCR) including an NCR mobile termination (NCR-MT) and an NCR forwarding (NCR-Fwd) in a wireless communication system, the NCR comprising:
a transceiver; and
at least one processor coupled with the transceiver and configured to:
receive, from a base station, side control information including information on a beam index and information on a time resource for communication on an NCR-Fwd access link, and
communicate, with a user equipment (UE) using a beam in a slot, based on the beam index and the time resource, wherein the slot is associated with a beam with a same index,
wherein data is forwarded between the base station and the UE via an NCR-Fwd backhaul link and the NCR-Fwd access link.

27. The NCR of claim 26,
wherein the time resource and the beam index corresponding to the time resource are indicated by downlink control information (DCI).

28. The NCR of claim 26,
wherein the information on the time resource includes at least one of a slot offset from a reference slot to the slot, a symbol offset from a first symbol in the slot, a reference subcarrier spacing (SCS), or a length of symbols in the slot, and
wherein a first SCS of a first slot which received downlink control information (DCI) is equal to a second SCS provided by the reference SCS.

29. The NCR of claim 28,
wherein the reference slot is a second slot with the second SCS, and
wherein the reference slot is identified based on capability information of the NCR.

30. The NCR of claim 26,
wherein, in case that a plurality of beam indexes for time resources are identified, the beam index corresponds to a most recent physical downlink control channel (PDCCH) monitoring occasion detected by the NCR.

31. A base station in a wireless communication system, the base station comprising:
a transceiver; and
at least one processor coupled with the transceiver and configured to:
transmit, to a network-controlled repeater (NCR) including an NCR mobile termination (NCR-MT) and an NCR forwarding (NCR-Fwd), side control information including information on a beam index and information on a time resource for communication on an NCR-Fwd access link, and
communicate, with a user equipment (UE) using a beam in a slot, based on the beam index and the time resource, wherein the slot is associated with a beam with a same index,
wherein data is forwarded between the base station and the UE via an NCR-Fwd backhaul link and the NCR-Fwd access link.

32. The base station of claim 31,
wherein the time resource and the beam index corresponding to the time resource are indicated by downlink control information (DCI).

33. The base station of claim 31,
wherein the information on the time resource includes at least one of a slot offset from a reference slot to the slot, a symbol offset from a first symbol in the slot, a reference subcarrier spacing (SCS), or a length of symbols in the slot,

34. The base station of claim 33,
wherein a first SCS of a first slot which received downlink control information (DCI) is equal to a second SCS provided by the reference SCS,
wherein the reference slot is a second slot with the second, and
wherein the reference slot is identified based on capability information of the NCR.

35. The base station of claim 31,
wherein, in case that a plurality of beam indexes for time resources are identified, the beam index corresponds to a most recent physical downlink control channel (PDCCH) monitoring occasion detected by the NCR.
